(19) United States
(12) Patent Application Publication
(10) Pub. No.: US 2026/0358477 A1
(43) Pub. Date: Nov. 12, 2026

(54) LIDAR system comprising tunable optical filters for controlling ambient light intensity

(71) Applicant: Innoviz Technologies Ltd., Rosh Ha’Ayin (IL)

(72) Inventors: David Elooz, Kfar Ha'Roe (IL); Nir Goren, Herut (IL); Yuval Yifat, Tel Aviv-Yafo (IL)

(21) Appl. No.: 19/645,348

(22) Filed: Apr. 13, 2026

Related U.S. Application Data
(60) Provisional application No. 63/804,010, filed on May 12, 2025.

(51) Int. Cl. G01S 7/481; G01S 7/486; G01S 7/4865; G01S 7/497; G01S 17/89; G01S 17/931

(52) U.S. Cl. CPC G01S 7/4816; G01S 7/4865; G01S 7/4868; G01S 7/497; G01S 17/89; G01S 17/931

(57) ABSTRACT

A LIDAR system comprising a light source configured to emit light projected towards a FOV of the LIDAR system, a tunable optical filter having a dynamically adjustable passband, a sensor configured to detect light received from the FOV via the tunable optical filter, and one or more processors configured to determine one or more ambient light conditions of an external environment of the LIDAR system, adjust a width of the passband of the tunable optical filter according to the one or more ambient light conditions to control an intensity of ambient light received from the FOV that is transmitted to the sensor via the tunable optical filter, receive ToF signal data generated by the sensor which is indicative of light projected by the LIDAR system and reflected from the FOV, and receive ambient light signal data generated by the sensor which is indicative of ambient light received from the FOV.

### TECHNICAL FIELD

The present disclosure relates to Light Detection and Ranging (LIDAR) technology for scanning a surrounding environment, and, more specifically, but not exclusively, for dynamically operating tunable optical filters according to ambient light conditions to control transmission and intensity of ambient light detected by the LIDAR sensor for constructing images of the FOV based on measured data indicative of the detected ambient light.

### BACKGROUND

With the advent of driver assist systems and autonomous vehicles, automobiles are equipped with systems capable of reliably sensing and interpreting their surroundings, including identifying obstacles, hazards, objects, and other physical parameters that might impact navigation of the vehicle. To this end, various technologies are currently used, for example, Radio Detection and Ranging (RADAR), LIDAR, camera-based systems, and/or the like operating alone, in conjunctions and/or in a redundant manner.

While primarily configured to receive light projected by the LIDAR system and reflected from objects in the FOV, a LIDAR sensor (sensor as used herein may include one or more sensors) may also receive light not associated with the light projected by the LIDAR system, designated ambient light herein, i.e., light originating from other light sources, for example, sunlight, light emitted by light sources external to the LIDAR system, and/or the like.

The ambient light detected by the LIDAR sensor may be used for constructing one or more images, for example, Infrared (IR) images of at least part of the FOV which may be used to increase detection performance of the LIDAR system.

### SUMMARY

It is an object of the present disclosure to provide methods, systems and/or software program products for using tunable optical filters to control the amount (intensity) of ambient light received by LIDAR system sensor from the FOV according to ambient light conditions detected in the environment of the LIDAR system in order to improve quality of images produced based on ambient light captured by the LIDAR system. This objective is achieved by the features of the independent claims. Further implementation forms are apparent from the dependent claims, the description, and the figures. It should be noted that multiple such implementation forms may be combined together to any single embodiment.

According to a first aspect of embodiments disclosed herein, there is provided a LIDAR system, comprising a light source configured to emit light projected towards a field of view (FOV) of the LIDAR system, a tunable optical filter having a dynamically adjustable passband, a sensor configured to detect light received from the FOV via the tunable optical filter, and one or more processors. The one or more processors are configured to determine one or more ambient light conditions of an external environment of the LIDAR system, adjust a width of the passband of the tunable optical filter according to the one or more ambient light conditions to control an intensity of ambient light received from the FOV that is transmitted to the sensor via the tunable optical filter, receive ToF signal data generated by the sensor, the ToF signal data is indicative of light projected by the LIDAR system and reflected from the FOV, and receive ambient light signal data generated by the sensor, the ambient light signal data is indicative of ambient light received from the FOV.

According to a second aspect of embodiments disclosed herein, there is provided a method of using a LIDAR system for receiving ambient light used to construct an image of a field of view (FOV) of the LIDAR system. The method comprising using one or more processors for determining one or more ambient light conditions of an external environment of the LIDAR system, adjusting a width of a passband of a tunable optical filter having a dynamically adjustable passband according to the one or more ambient light conditions to control an intensity of ambient light received from the FOV that is transmitted to a sensor of the LIDAR system via the tunable optical filter, the tunable optical filter is positioned downstream from the sensor, i.e., between the sensor and the FOV, such that the sensor receives light from the FOV via the tunable optical filter, receiving ToF signal data generated by the sensor, the ToF signal data is indicative of light projected by the LIDAR system and reflected from the FOV, and receiving ambient light signal data generated by the sensor, the ambient light signal data is indicative of ambient light received from the FOV.

In a further implementation form of the first, and/or second aspects optionally together with one or more of the other implementation forms, the ambient light signal data is used for constructing an image of at least part of the FOV.

In a further implementation form of the first, and/or second aspects optionally together with one or more of the other implementation forms, the one or more ambient light conditions are members of a group consisting of: an intensity of the ambient light, and/or a wavelength of the ambient light.

In a further implementation form of the first, and/or second aspects optionally together with one or more of the other implementation forms, the one or more processors are configured to adjust the width of the passband of the tunable optical filter to transmit sufficient ambient light to the sensor for constructing the image of at least part of the FOV, such that: in response to identifying low ambient light conditions, the one or more processors increase the width of the passband of the tunable optical filter, and in response to identifying high ambient light conditions, the one or more processors reduce the width of the passband of the tunable optical filter.

In a further implementation form of the first, and/or second aspects optionally together with one or more of the other implementation forms, the sufficient ambient light is determined based on comparison of an intensity of ambient light detected by the sensor and one or more predefined thresholds.

In a further implementation form of the first, and/or second aspects optionally together with one or more of the other implementation forms, the one or more processors are further configured to adjust the width of the passband of the tunable optical filter according to a tradeoff between sufficient ambient light and reduced ambient light noise.

In a further implementation form of the first, and/or second aspects optionally together with one or more of the other implementation forms, the tunable optical filter is operable to adjust the width of the passband within a predefined width range.

In a further implementation form of the first, and/or second aspects optionally together with one or more of the other implementation forms, the tunable optical filter is operable to select the width of the passband from a plurality of discrete width values.

In a further implementation form of the first, and/or second aspects optionally together with one or more of the other implementation forms, the tunable optical filter comprises a mechanically movable optical filter having at least two states. Wherein in a first state of the at least two states, the movable optical filter is positioned in an inbound optical path directing the light received from the FOV toward the sensor, and in a second state of the at least two states, the movable optical filter is positioned out of the inbound optical path.

In a further implementation form of the first, and/or second aspects optionally together with one or more of the other implementation forms, the tunable optical filter comprises a mechanically movable optical filter having at least two states. Wherein in a first state of the at least two states, a first filtering region of the mechanically movable optical filter is positioned in an inbound optical path directing the light received from the FOV toward the sensor, and in a second state of the at least two states, a second filtering region of the mechanically movable optical filter is positioned in the inbound optical path. Wherein the first filtering region is configured to transmit a different wavelength range from the second filtering region.

In a further implementation form of the first, and/or second aspects optionally together with one or more of the other implementation forms, the tunable optical filter comprises an optical low pass filter (LPF) and an optical high pass filter (HPF) combined to form the passband, one or more of the LPF and the HPF are mechanically adjustable to adjust the width of the passband.

In an optional implementation form of the first, and/or second aspects optionally together with one or more of the other implementation forms, the LIDAR system further comprises a fixed optical filter associated with the sensor. The fixed optical filter is deployed in an inbound optical path directing the light received from the FOV toward the sensor such that the light received by the sensor from the FOV is transmitted via the fixed optical sensor and the tunable optical filter. Wherein the fixed optical filter comprises at least two fixed passbands, a first fixed passband corresponding to a wavelength of the light projected by the light source of the LIDAR system and a second fixed passband excluding (not comprising) the wavelength of the projected light. Wherein the width of the passband of the tunable optical filter is adjustable to at least a first passband and a second passband, the first passband corresponds to the first fixed passband of the fixed optical filter, and the second passband corresponds to both the first fixed passband and the second fixed passband of the fixed optical filter.

In an optional implementation form of the first, and/or second aspects optionally together with one or more of the other implementation forms, the fixed optical filter is removed from the inbound optical path in the second state.

In a further implementation form of the first, and/or second aspects optionally together with one or more of the other implementation forms, the tunable optical filter comprises one or more of: a liquid crystal tunable filter (LCTF), a ring resonator, and/or an acousto-optical tunable filter (AOTF).

In a further implementation form of the first, and/or second aspects optionally together with one or more of the other implementation forms, the tunable optical filter is configured such that the passband of the tunable optical filter includes a wavelength of the light projected by the LIDAR system.

In an optional implementation form of the first, and/or second aspects optionally together with one or more of the other implementation forms, the one or more processors are further configured to adjust a center wavelength of the passband of the tunable optical filter according to a wavelength of the light projected by the LIDAR system.

In a further implementation form of the first, and/or second aspects optionally together with one or more of the other implementation forms, one or more of the ambient light conditions are identified based on signal data generated by the sensor.

In a further implementation form of the first, and/or second aspects optionally together with one or more of the other implementation forms, one or more of the ambient light conditions are identified based on data generated by one or more another sensor different from the sensor.

In a further implementation form of the first, and/or second aspects optionally together with one or more of the other implementation forms, the ambient light signal data is generated by the sensor during one or more time periods during which the light projected by the LIDAR system and reflected from one or more objects in the FOV is estimated not to be received by the sensor.

An optional implementation form of the first, and/or second aspects optionally together with one or more of the other implementation forms, the one or more processors are further configured to adjust the width of the passband of the tunable optical filter in real-time. The real-time adjustment of the bandpass width comprises adjusting the passband width to set an increased width passband during one or more first time periods of one or more scan cycles of the FOV during which the light projected by the LIDAR system and reflected from the FOV is estimated not to arrive the sensor, and adjusting the passband width to set a reduced width passband corresponding to a wavelength of the light projected by the LIDAR system during one or more second time periods of the one or more scan cycles during which the light projected by the LIDAR system and reflected from the FOV is estimated to arrive the sensor.

Consistent with other disclosed embodiments, non-transitory computer-readable storage media may store program instructions, which are executed by at least one processor and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments by way of example only. With specific reference now to the drawings in detail, it is stressed that the particulars are shown by way of example and for purposes of illustrative discussion of embodiments disclosed herein. In this regard, the description taken with the drawings makes apparent to those skilled in the art how disclosed embodiments may be practiced.

The accompanying drawings, which are incorporated in and constitute a part of this disclosure, illustrate various disclosed embodiments.

In the drawings:

FIG. 1 and FIG. 2 are schematic illustrations of an exemplary LIDAR system, in accordance with embodiments of the present disclosure;

FIG. 3 is a schematic illustration of an exemplary LIDAR system comprising one or more tunable optical filters positioned for transmitting light received from a FOV of the LIDAR system to one or more sensors of the LIDAR system, in accordance with embodiments of the present disclosure;

FIG. 4A, FIG. 4B, and FIG. 4C depict graph charts illustrating transfer functions of exemplary tunable optical filters positioned in a LIDAR system for transmitting light received from a FOV of the LIDAR system to one or more sensors of the LIDAR system, in accordance with embodiments of the present disclosure;

FIG. 5 depicts graph charts illustrating transfer functions of exemplary tunable optical filters having a moveable and adjustable passband which is positioned in a LIDAR system for transmitting light received from a FOV of the LIDAR system to one or more sensors of the LIDAR system, in accordance with embodiments of the present disclosure;

FIG. 6 depicts graph charts illustrating transfer functions of an exemplary tunable optical filter combined with a fixed optical filter both positioned in a LIDAR system for transmitting light received from a FOV of the LIDAR system to one or more sensors of the LIDAR system, in accordance with embodiments of the present disclosure;

FIG. 7A and FIG. 7B are schematic illustrations of some exemplary mechanical optical filters of a LIDAR system which are moveable between states to adjust their passband width for transmitting light received from a FOV of the LIDAR system to one or more sensors of the LIDAR system, in accordance with embodiments of the present disclosure;

FIG. 8 depicts graph charts illustrating transfer functions of exemplary optical LPF and HPF positioned in a LIDAR system for transmitting light received from a FOV of the LIDAR system to one or more sensors of the LIDAR system, in accordance with embodiments of the present disclosure;

FIG. 9A and FIG. 9B are schematic illustrations of some exemplary mechanical LPF and HPF of a LIDAR system which are moveable between states to adjust their passband width for transmitting light received from a FOV of the LIDAR system to one or more sensors of the LIDAR system, in accordance with embodiments of the present disclosure; and

FIG. 10 is a flow chart of an exemplary process of adjusting passband width of one or more tunable optical filters positioned in a LIDAR system for transmitting light received from a FOV of the LIDAR system to one or more sensors of the LIDAR system, in accordance with embodiments of the present disclosure.

### DETAILED DESCRIPTION

The present disclosure relates to Light Detection and Ranging (LIDAR) technology for scanning a surrounding environment, and, more specifically, but not exclusively, for dynamically operating tunable optical filters according to ambient light conditions to control transmission and intensity of ambient light detected by the LIDAR sensor for constructing images of the FOV based on sensory data indicative of the detected ambient light.

LIDAR systems are configured to detect objects in their external environment by scanning the external environment, specifically scanning a certain Field of View (FOV) defined by a certain angular extent, for example, a horizontal angular extent and a vertical angular extent. The LIDAR system may project light, for example, laser light to illuminate the FOV and detect objects in the FOV based on their reflection of the light projected by the LIDAR system.

The LIDAR system includes one or more light sensors (interchangeably designated sensors, detectors, and/or light detectors herein) configured to receive light from the FOV and generate signal data indicative of the light detected by the sensors (sensor as used herein may include one or more light sensors). The light received from the FOV may include light projected by the LIDAR system and reflected from one or more objects in the FOV. The signal data generated by the sensor which is indicative of the projected light that is reflected from the FOV may be used to detect objects in the FOV and one or more attributes of the detected objects. These attributes may primarily include position of objects (in one or more coordinate systems), and distance of the objects (from the LIDAR system). However, the attributes of one or more of the detected objects may further include one or more additional attributes, for example, motion (e.g., velocity, acceleration, etc. whether in absolute, and/or relative terms), reflectivity, and/or the like.

While configured to detect the light projected by the LIDAR system and reflected from the FOV, the sensor of the LIDAR system may also detect light, designated ambient light hereinafter, which is received from the FOV and is unrelated to the light projected by the LIDAR system, i.e., the ambient light that does not originate from the LIDAR system and is therefore not associated with the LIDAR system. Rather, the ambient light may originate from one or more other light sources, for example, sunlight, external light sources, and/or the like. In particular, the sensor may detect ambient light in one or more spectral regions that the sensor is sensitive to, for example, light in the Infrared (IR) spectrum such as, for example, Near IR (NIR), Short-Wavelength Infrared (SWIR), and/or the like. As known in the art, frequency and wavelength are related terms, specifically inverse to one another, and the terms spectral region or spectral range and wavelength region or wavelength range are used interchangeably herein.

In response to detection of the ambient light the sensor may generate signal data, designated ambient light signal data, indicative of the detected ambient light. The ambient light signal data may be used to construct one or more images of the FOV and/or part thereof, for example, IR images (interchangeably designated ambient image, noise image, and/or simply images herein). These IR images may be used for analyzing the environment of the LIDAR system to detect objects and their attributes, typically coupled with analysis of the ToF signal data, thus significantly improving object detection performance of the LIDAR system, for example, accuracy, reliability, consistency, robustness, and/or the like.

Obviously, the quality of the IR images generated based on the ambient light signal data generated by the LIDAR sensor, for example, accuracy, clarity, brightness, contrast, and/or the like may depend on the level (intensity, energy, amount) of ambient light detected by the sensor. The level of ambient light detected by the sensor may be affected by one or more ambient light conditions in the environment of the LIDAR system, for example, an intensity of ambient light, a wavelength of ambient light, and/or the like. The term intensity as used herein may refer to the amount of light, for example, photon count, etc. As such, higher intensity may refer to more light, while reduced intensity may refer to less light.

For example, under low illumination conditions, i.e., low intensity ambient light, e.g., at night, in a tunnel, in a closed parking lot, and/or the like, the sensor may detect limited ambient light which may result in poor quality images. In another example, under high illumination conditions, i.e., high intensity ambient light, for example, during sunny days, in IR intense environment, and/or the like, the sensor may detect high levels of ambient light which may also degrade quality of the images due to one or more limitations, for example, excessive noise, saturation of the sensor, reduced dynamic range, and/or the like. In particular, environmental noise may reduce accuracy and/or range of ToF detections under high ambient light conditions, whereas in case of low ambient light conditions the noise may be less significant to ToF detections and may have limited or even no impact and/or degradation effect on the ToF detections.

According to some embodiments of the present disclosure, there are provided devices, systems, methods, and software program products for controlling one or more tunable optical filters of a LIDAR system in order to control the level (amount, intensity, energy) of light received from the FOV and detected by the LIDAR system sensor, specifically the level of ambient light received and detected by the sensor. For brevity, the term optical filter is designated herein after in singular form but may include one or more optical filter. In order to control the level of the ambient light received by the sensor from the FOV, the tunable optical filter may be positioned, configured, and/or adapted such that the sensor of the LIDAR system may detect light that is received from the FOV via the tunable optical filter.

An optical filter (interchangeably designated light filter herein) is a device which, as known in the art, may transfer light in a spectral range corresponding to the pass region (passband) of the optical filter.

In particular, the tunable optical filter, typically implementing a Band Pass Filter (BPF), may have a dynamically adjustable passband such that the tunable optical filter may be operated to dynamically adjust a width of the optical filter's passband according to one or more ambient light conditions detected in the external environment of a LIDAR system, for example, ambient light intensity, ambient light wavelength, and/or the like.

Detecting the ambient light conditions in the external environment of the LIDAR system may be done based on sensory data received from one or more sensors, for example, the LIDAR sensor, one or more other sensors (e.g., light sensor), separate from the LIDAR sensor, and/or a combination thereof.

The width of the tunable optical filter passband width may be then adjusted according to one or more of the determined ambient light conditions. In particular, the tunable optical filter passband width may be adjusted according to the ambient light conditions to allow sufficient ambient light to be detected by the sensor for constructing images of the FOV. Moreover, while ensuring sufficient ambient light to be detected by the sensor, the passband width may be adjusted to reduce the level of optical noise induced by the ambient light received and detected by the sensor from the FOV.

For example, assuming it is determined that there are currently low illumination conditions, i.e., low intensity ambient light (e.g., night, tunnel, closed parking lot, etc.), the width of the passband of the tunable optical filter may be adjusted to increase the passband width so that increased level of ambient light may be received by the sensor from the FOV via the tunable optical filter. In another example, assuming it is determined that there are currently high illumination conditions, i.e., high intensity ambient light (e.g., sun radiation, external light source, etc.), the width of the passband of the tunable optical filter may be adjusted to decrease (reduce) the passband width so that reduced level of ambient light may be received by the sensor from the FOV via the tunable optical filter and thus reduced level of optical noise, increase dynamic range (e.g., by preventing saturation of the sensor), and/or the like.

The tunable optical filter may support one or more operation modes and/or passband width adjustment mechanisms.

For example, in some embodiments, the tunable optical filter may support a two state configuration in which the tunable optical filter may be operated to transition between two states. In a first state, the tunable optical filter may be operated to set a narrow passband for high ambient light conditions in order to reduce ambient light and hence optical noise transmitted to the sensor. In a second state, the tunable optical filter may be operated to set a wide passband for low ambient light conditions in order to increase ambient light transmitted to the sensor.

In another example, in some embodiments, the tunable optical filter passband may support multi passband width configuration in which the width of the passband may be set to a plurality of different width values (e.g., multiple discrete width values, a predefined range of width values, etc.). As such, the passband width may be selected, according to the ambient light conditions, from the plurality of width values and/or within the predefined range, specifically to support sufficient light and reduced optical noise. Sufficient ambient light may be determined, and/or computed, for example, using one or more predefined thresholds defining a level of ambient light that is empirically known to produce quality images (IR images). Similarly, optical noise level may be determined, and/or computed, using one or more predefined thresholds defining a maximal noise level which is empirically determined to induce an acceptable degradation to the images. In another example, sufficient ambient light, maximal noise level, and/or the like may be determined based on one or more images constructed in real-time based on the ambient light signal data generated by the sensor. In another example, the width of the tunable optical filter passband may be adjusted based on optimization and/or tradeoff between the sufficient light requirements and the reduced optical noise requirement.

The tunable optical filter may employ one or more technologies, architectures, designs, and/or structures which may support one or more of the operation modes and/or passband width adjustment mechanisms described hereinbefore.

For example, the tunable optical filter may include a mechanically moveable light filter, which optionally may be a fixed passband filter. The moveable light filter may be moved (e.g., slid, rotated, pivoted, etc.) in and out of the reception (RX) optical path of the LIDAR system. In a first state, the moveable light filter may be moved to be positioned in the reception optical path such that the light received by the sensor may be directly received from the FOV. In a second state, the moveable light filter may be moved to be positioned in the reception optical path such that the light received by the sensor may transfer (transmit) via the moveable light filter.

In another example, the tunable optical filter may be utilized by a combination of an optical Low Pass Filter (LPF) and an optical High Pass Filter (HPF) which may be dynamically adjustable with respect to each other to form the passband of the tunable optical filter. This architecture may support the two state configuration. In such configuration, in the first state, the optical LPF and HPF may be moved (e.g., slid, rotated, pivoted, etc.) out of the reception optical path of the LIDAR system such that the light received by the sensor may be directly received from the FOV, while in the second state, the optical LPF and the optical HPF may be both moved into reception optical path such that the light received by the sensor may transfer (transmit) via both the LPF and HPF forming the passband. However, in some embodiments the LPF/HPF architecture may support multi passband width configuration in which the passband width of the LPF/HPF combination may be defined by the position of the optical LPF and the optical HPF with respect to each other. In such configurations, the passband width may be adjusted by mechanically moving, aligning, and/or orienting (e.g., sliding, rotating, pivoting, etc.) the optical LPF and the optical HPF with respect to each other.

In another example, the tunable optical filter may include one or more electrically controlled band pass filters, for example, a Liquid Crystal Tunable Filter (LCTF), a ring resonator, an Acousto-Optical Tunable Filter (AOTF), and/or the like. These tunable optical filter architectures are controllable through one or more excitation signals, for example, a current, a voltage, an electric field, a magnetic field, a soundwave, and/or the like. Through application of different values of the excitation signals, the tunable optical filter may be excited, configured, and/or operated to support the two state configuration and/or the multi passband width configuration.

In order to enable the fundamental operation mode of the LIDAR system, namely detecting objects based on analysis of light projected to illuminate the FOV and reflected from objects in the FOV, the passband of the tunable optical filter may be configured, adjusted, and/or operated to include the wavelength of the light projected by the LIDAR system. This means that the presence of the tunable optical filter on the reception optical path may not affect and/or impact the LIDAR system sensor ability and/or performance in detecting light projected by the LIDAR systems and reflected from objects in the FOV. The tunable optical filters may therefore not hinder or degrade object detection performance of the LIDAR system which is based on analysis of the signal data generated by the sensor that is indicative of the light that is projected by the LIDAR system and reflected from objects in the FOV.

Optionally, the passband of the tunable optical filter may be configured, adjusted, and/or operated to adjust the center wavelength of the passband such that the passband includes the wavelength of the light projected by the LIDAR system.

As described herein before, the ambient light signal data generated by the sensor may be used to create one or more images. Therefore, in order to avoid effects of the light projected by the LIDAR system on the ambient light signal data, the sensor may be configured, and/or operated to detect ambient light and generate ambient light signal data accordingly during one or more time periods when the projected light is estimated not to be received by the sensor.

For example, during each scan cycle of the FOV by the LIDAR system, there may be a plurality of (active) time periods during which light is projected by the LIDAR system and reflected from objects in the FOV back towards the LIDAR system such that the reflected light may be detected by the LIDAR sensor. The duration of the active time periods, during which the projected light may be received by the sensor, may depend on one or more operational parameters of the LIDAR system, for example, intensity of projected light, scan range, and/or the like.

As such, during each scan cycle there may be one or more (passive) time periods during which light projected by the LIDAR system is not expected to be received by the sensor, i.e., light projected by the LIDAR system is estimated not to be received by the sensor. During the passive time periods, the sensor may therefore generate ambient light signal data which may be unaffected by the light projected by the LIDAR system and may be thus indicative of ambient light that is unrelated to the projected light.

Controlling the level of ambient light directed in a LIDAR system from its FOV to the LIDAR system sensor according to ambient light conditions in its external environment may present major benefits and advantages over currently existing LIDAR systems.

First, deploying tunable optical filters in a LIDAR system and adjusting the width of their passband to control the level of ambient light received by sensor of the LIDAR system may allow sufficient ambient light and/or reduced optical noise to be detected by the sensor which may thus significantly improve quality of images constructed based on ambient light signal data generated by the sensor (e.g., accuracy, clarity, brightness, contrast, resolution, etc.) compared to images constructed using signal data captured by existing LIDAR systems. For example, increasing the passband width under low illumination conditions, i.e., low intensity ambient light, may increase the level of ambient light detected by the sensor which may significantly improve quality of images constructed based on the ambient light data generated by the sensor compared to poor quality images constructed using sensory data generated by existing LIDAR systems due to insufficient ambient light detected by their sensors. In another example, reducing the passband width under high illumination conditions, i.e., high intensity ambient light, may reduce level of optical noise (ambient light noise) which may also significantly improve quality of images constructed based on the ambient light data generated by the sensor compared to poor quality images constructed using sensory data generated by existing LIDAR systems due to excessive optical noise levels.

Increased quality images of the FOV and/or part thereof may significantly increase object detection performance of the LIDAR system since these images may be used in combination and/or to complement one or more 3D models, for example, a point cloud, a polygon mesh, and/or the like created based on sensory data generated by the sensor which is indicative of light projected by the LIDAR system (e.g., laser beams) and reflected from one or more objects in the FOV. For example, data extracted from the ambient light images may be useful to identify features, objects, and/or elements in the FOV which may be undetected and/or poorly detected in the point cloud. In another example, detection confidence may be increased by combining detection scores of objects in the point cloud with detection scores of corresponding objects in the ambient light images.

Moreover, adjusting the width of the passband of the tunable optical filter within a range of width values, according to current ambient light conditions, may further improve quality of one or more images constructed using the ambient light signal data since the level of ambient light transmitted to the sensor may be controlled with increased granularity, flexibility, and/or accuracy in order to transmit sufficient light while reducing optical noise.

Furthermore, adjusting the passband of the tunable optical filter to track the wavelength of the light projected by the LIDAR system may significantly increase the amount of light reflected from the FOV (in response to the projected light) that is received and detected by the sensor since this reflected light is not blocked by the tunable optical filter, or at least mostly unblocked by the tunable optical filter. This may prevent degradation of object detection performance of the LIDAR system. In fact, positioning the tunable optical filter on the optical reception path of the LIDAR system and adjusting their passband width to include the wavelength of the projected light may increase the LIDAR's object detection performance since optical noise may be reduced during the time periods when the reflected light is detected and measured by the sensor thus increasing integrity, accuracy, and/or robustness of the sensor generated signal data which is of the light that is projected by the LIDAR system and reflected from objects in the FOV.

The following detailed description refers to the accompanying drawings. Wherever possible, the same reference numbers are used in the drawings and the following description to refer to the same or similar parts.

While illustrative embodiments are described herein, it is to be understood that these are not necessarily limited in their application to the details of construction and/or arrangement of the components, systems, or methods, since modifications, adaptations and other implementations are possible. For example, as may be appreciated by one skilled in the art, substitutions, additions, and/or modifications may be made to the components illustrated in the drawings, and the illustrative methods described herein may be modified by substituting, reordering, removing, or adding steps to the disclosed methods.

Accordingly, the following detailed description is not limited to the disclosed embodiments and examples. Instead, the proper scope is defined by the appended claims.

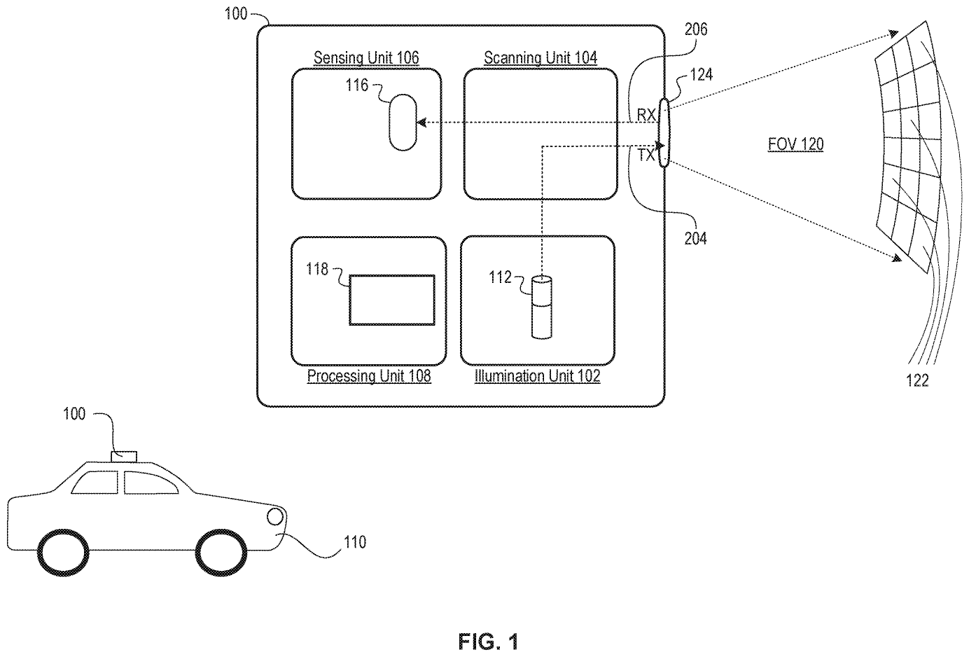

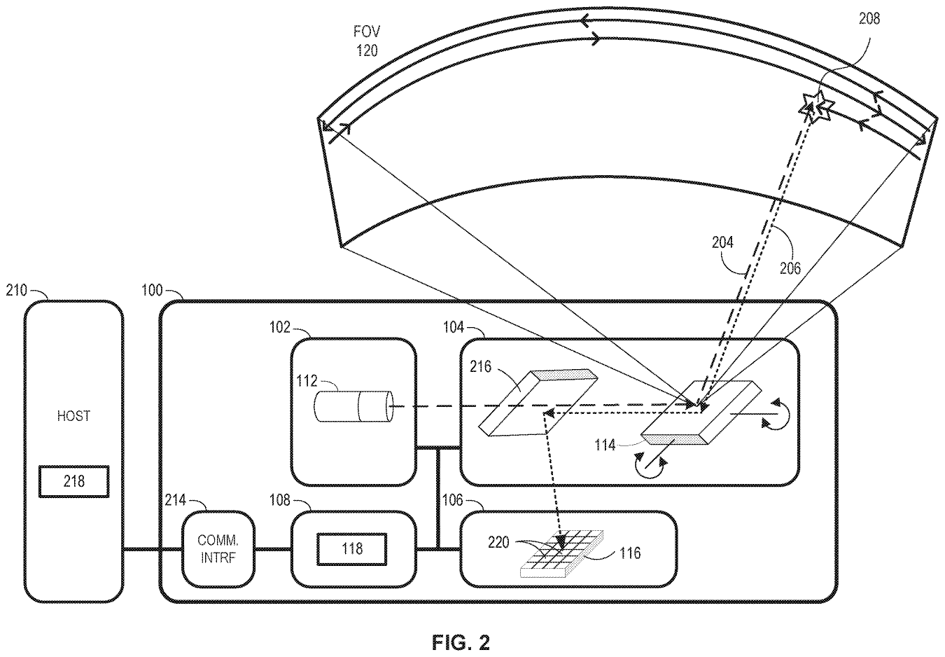

Referring now to the drawings, FIG. 1 and FIG. 2 are schematic illustrations of an exemplary LIDAR system, in accordance with embodiments of the present disclosure.

An exemplary LIDAR system 100 may be used, for example, in one or more ground autonomous or semi-autonomous vehicles 110, for example, road-vehicles such as, for example, cars, buses, vans, trucks and any other terrestrial vehicle. Autonomous ground (land) vehicles 110 equipped with the LIDAR system 100 may scan their environment and, using data derived from the scanning, may drive to a destination with reduced and potentially no human intervention. In another example, the LIDAR system 100 may be used in one or more autonomous/semi-autonomous aerial-vehicles such as, for example, Unmanned Aerial Vehicles (UAV), drones, quadcopters, and/or any other airborne vehicle or device. In another example, the LIDAR system 100 may be used in one or more autonomous or semi-autonomous water vessels such as, for example, boats, ships, hovercrafts, submarines, and/or the like. As described for the ground vehicles, such autonomous aerial-vehicles and watercrafts with LIDAR system 100 may scan their environment and, using data derived from the scanning, may navigate to a destination autonomously or under limited remote human operation.

It should be noted that the LIDAR system 100 or any of its components may be used together with any of the example embodiments and methods disclosed herein. Moreover, while aspects of the LIDAR system 100 may be described herein with respect to an exemplary vehicle-based LIDAR platform, the LIDAR system 100, any of its components, or any of the processes described herein may be applicable to one or more LIDAR systems of other platform types. As such, LIDAR systems such as the LIDAR system 100 may be installed, mounted, integrated, and/or otherwise deployed, in dynamic and/or stationary deployment for one or more other applications, for example, a surveillance system, a security system, a monitoring system, and/or the like. Such LIDAR systems 100 may be configured to scan their environment in order to detect objects according to their respective application needs, criteria, requirements, and/or definitions.

The LIDAR system 100 may be configured to detect tangible objects in an environment of the LIDAR system 100, specifically in a scene contained in a Field of View (FOV) 120 of the LIDAR system 100. The LIDAR system 100 may detect object in the FOV 120 based on reflected light, specifically based on light projected by the LIDAR system 100 and reflected by objects in the FOV 120, and more specifically based on differences identified and/or measured in one or more parameters of the projected light compared to the reflected light, for example, timing, phase, frequency, amplitude, etc. and/or a combination thereof.

The scene may include some or all objects within the FOV 120, in their relative positions and in their current states. The objects which may be static and/or dynamic may include, for example, ground elements (e.g., earth, roads, grass, sidewalks, road surface marking, etc.), sky, man-made objects (e.g., vehicles, buildings, signs, landmarks, etc.), vegetation, people, animals, light projecting elements (e.g., flashlights, sun, other LIDAR systems, etc.), and/or the like.

An object refers to a finite composition of matter that may reflect light from at least a portion thereof. An object may be at least partially solid (e.g., car, tree, etc.), at least partially liquid (e.g., puddles on a road, rain, etc.), at least partly gaseous (e.g., fumes, clouds, etc.), made of a multitude of distinct particles (e.g., sandstorm, fog, spray, etc.), and/or a combination thereof. An object may be of one or more scales of magnitude, such as, for example, ~1 millimeter (mm), ~5 mm, ~10 mm, ~50 mm, ~100 mm, ~500 mm, ~1 meter (m), ~5 m, ~10 m, ~50 m, ~100 m, and so on.

The LIDAR system 100 may be configured to detect objects by scanning the environment of the LIDAR system 100, i.e., projecting light to illuminate at least part of the FOV 120 of the LIDAR system 100 and collecting and/or receiving light reflected from (scattered of) objects in the FOV 120 which are illuminated by the light projected by the LIDAR system. The LIDAR system 100 may scan the FOV 120 and/or part thereof in a plurality of scan cycles (frames) conducted at one or more frequencies (frame rate), for example, 5 frames per second (fps), 10 fps, 15 fps, 20 fps, and/or the like.

The LIDAR system 100 may apply one or more scanning mechanisms, methods, and/or implementations for scanning the environment. For example, the LIDAR system 100 may scan the environment by moving and/or pivoting one or more deflectors configured to deflect light emitted from one or more light sources of the LIDAR system 100 in differing directions toward distinct parts of the FOV 120. In another example, the LIDAR system 100 may scan the environment by changing positioning (i.e., location and/or orientation) of one or more light sensor (interchangeably designated sensors, detectors, and/or light detectors) associated with the LIDAR system 100 with respect to the FOV 120. In another example, the LIDAR system 100 may scan the environment by changing positioning (i.e., location, and/or orientation) of one or more of the light sources associated with the LIDAR system 100 with respect to the FOV 120. In another example, the LIDAR system 100 may scan the environment by changing the positioning of the sensor and the light source(s) associated with the LIDAR system 100 with respect to the FOV 120. In another example, the LIDAR system 100 may comprise an array of light sources each positioned, oriented, configured, and/or operated to scan a respective portion of the FOV 120.

The LIDAR system 100 may employ one or more detection technologies. For example, the LIDAR system 100 may employ ToF detection where the light signal emitted by the light source(s) of the LIDAR system 100 and projected to illuminate the FOV 120 may comprise one or more short pulses, whose rise and/or fall time may be detected in a received signal reflected by one or more objects in the FOV 120 which are illuminated with the projected light. In another example, the LIDAR system 100 may employ Continuous Wave (CW) detection, for example, Frequency Modulated CW (FMCW), Phase Modulation CW (PMCW, also designated phase-shifting), Multi-Tone CW (MTCW), and/or the like in which a continuous wave light signal is transmitted. The transmitted light signal is compared with a received light signal reflected by one or more objects in the FOV 120 illuminated with the transmitted light signal to identify and/or measure difference and/or shift in one or more parameters (e.g., phase, frequency, amplitude, etc.) between the transmitted light signal and the reflected light signal. The distance, velocity, and/or one or more additional attributes (e.g., reflectivity, etc.) of the reflecting objects may be determined based on the identified differences between the transmitted and reflected light signals.

The FOV 120 scanned by the LIDAR system 100, i.e., the environment in which the LIDAR system 100 may detect objects, may include an extent of the observable environment of LIDAR system 100. The extent of the FOV 120 may be defined and/or expressed, for example, by a horizontal range (e.g., 50°, 120°, 360°, etc.), and a vertical elevation (e.g., ±20°, +40°-20°, ±90°, 0°-90°, etc.). The FOV 120 may also be defined within a certain range, for example, up to a certain depth/distance (e.g., 100 m, 200 m, 300 m, etc.), and up to a certain vertical distance (e.g., 10 m, 25 m, 50 m, etc.).

The FOV 120 may be divided (segmented) into a plurality of portions 122 (segments), also designated FOV pixels, having uniform and/or different sizes. In some embodiments, as illustrated in FIG. 1, the FOV 120 may be divided into a plurality of portions 122 arranged in the form of a two-dimensional array of rows and columns. At any given time during a scan of the FOV 120, the LIDAR system 100 may scan an instantaneous FOV which may comprise one or more respective portions 122. Obviously, the portion 122 scanned during each instantaneous FOV may be narrower than the entire FOV 120, and the LIDAR system 100 may thus move the instantaneous FOV within the FOV 120 in order to scan the entire FOV 120. However, in some embodiments, the instantaneous FOV may include the entire FOV 120.

Detecting an object may broadly refer to determining an existence of the object in the FOV 120 of the LIDAR system 100 which reflects light projected by the LIDAR system 100 back toward one or more light sensors (designated sensor herein after for brevity) associated with the LIDAR system 100. Additionally, or alternatively, detecting an object may refer to determining one or more physical parameters relating to the detected object and generating information indicative of the determined physical parameters, for example, a distance between the detected object and one or more other objects (e.g., the LIDAR system 100, another object detected in the FOV 120, ground (earth), etc.), a kinematic parameter of the detected object (e.g., relative velocity, absolute velocity, movement direction, expansion of the object, etc.), a reflectivity (level) of the detected object, and/or the like.

The LIDAR system 100 may detect objects in the scanned FOV 120 and/or part thereof by processing detection results based on sensory data received from the sensor which is indicative of the light signals reflected from one or more objects in the FOV 120 illuminated with the light emitted (projected) by the LIDAR system. For example, in a ToF based LIDAR system 100, such sensory data may include temporal information indicative of a period of time between the emission of a light signal (pulse) by the light source(s) of the LIDAR system 100 and the time of detection of a reflected light signal (pulse) by the sensor associated with the LIDAR system 100. In another example, in a CW based LIDAR system 100, the sensory data may include information indicative of one or more differences between the transmitted light signal, specifically a reference light signal replicating the transmitted light signal, and the reflected light signal, for example, a frequency difference, a phase difference, and/or the like.

For various reasons, the LIDAR system 100 may detect only partially one or more objects which are present (located) in the FOV 120. For example, light may be reflected from only some sides of an object, typically the side(s) opposing the LIDAR system 100 which may be therefore detected by the LIDAR system 100. In another example, light emitted by the LIDAR system 100, for example, a laser beam may be projected on only part of an object projected onto a road or a building. In another example, an object may be partly blocked and/or obscured by another object between the LIDAR system 100 and the detected object. In another example, ambient light and/or one or more other interferences (e.g., adversarial environmental conditions) may interfere with detection of one or more portions of an object.

Optionally, detecting an object by the LIDAR system 100 may further refer to identifying the object, for example, classifying a type of the object (e.g., car, person, tree, road, traffic light, etc.), recognizing a specific object (e.g., natural site, structure, monument, etc.), determining a text value of the object (e.g., license plate number, road sign markings, etc.), determining a composition of the object (e.g., solid, liquid, transparent, semitransparent, etc.), and/or the like.

As seen in FIG. 1, the LIDAR system 100 may comprise an illumination unit 102, a scanning unit 104, a sensing unit 106, and a processing unit 108. According to some embodiments, the LIDAR system 100 may be mountable on a vehicle 110.

Optionally, the LIDAR system 100 may be associated with one or more optical windows 124 through which outgoing light may be projected toward the FOV 120 and/or through which incoming light reflected from objects in field of view 120 may be received in the LIDAR system 100. The window 124 may include, for example, a window of the LIDAR system 100, a window of the vehicle 110 (e.g., windshield) behind which the LIDAR system 100 is installed, a cover of a lamp in which the LIDAR system 100 is installed, and/or the like. Optionally, the optical window(s) 124, for example, an opening, a flat window, a lens, or any other type of optical window may be used for one or more purposes, for example, collimating the projected light, focusing of the reflected light, and/or the like.

The LIDAR system 100 may be contained in a single housing and/or divided among a plurality of housings connected to each other via one or more communication channels, for example, a wired channel, a fiber optics cable, and/or the like deployed between the first and second housings, a wireless connection (e.g., RF channel and/or network), and/or any combination thereof. For example, the light related components of the LIDAR system 100, i.e., the illumination unit 102, the scanning unit 104, and the sensing unit 106 may be deployed and/or contained in a first housing while the processing unit 108 may be deployed and/or contained in a second housing. In such case, the processing unit 108 may communicate with the illumination unit 102, the scanning unit 104, and/or the sensing unit 106 via the communication channel(s) connecting the separate housings for controlling of the scanning unit 104 and/or for receiving from the sensing unit 106 sensory information indicative of light reflected from the scanned scene.

The LIDAR system 100 may apply one or more scanning modes, technologies, and/or techniques for scanning the FOV 120. For example, the LIDAR system 100 may apply raster (flying spot) scanning in which one or more light beams, for example, laser beams, are projected to scan the FOV 120 in one or more scan patterns, for example, side to side horizontal scanning of lines, up-down vertical scanning of columns, etc. and/or a combination thereof. In such case, the FOV 120 may be segmented to the plurality of segments 122 each corresponding to an instantaneous FOV scanned by the raster LIDAR system 100 at a given time during a scan cycle. In another example, the LIDAR system 100 may apply scan-line scanning in which one or more light beams projected simultaneously by the LIDAR system 100 may form a beam array, and/or an elongated light beam, for example, a vertically elongated and/or arrayed line beam (e.g., laser beams) which may be varied (moved) horizontally to scan the FOV 120. In such case, the instantaneous FOV scanned by the scan-line LIDAR system 100 at any given time during a scan cycle may comprise a respective vertical portion of the FOV 120, for example, a column of segments 122. In another example, the LIDAR system 100 may apply flash scanning in which one or more light beams (e.g., laser beams) may be projected by the LIDAR system 100 to simultaneously illuminate the entire FOV 120 such that the instantaneous FOV scanned by the flash LIDAR system 100 at any given time during a scan cycle may comprise the entire FOV 120.

The LIDAR system 100 may employ one or more designs, architectures, and/or configurations, optionally depending on the scanning mode of the LIDAR system 100, for implementing optical paths, specifically an outbound optical path (transmission path TX) for transmitting (projecting) light 204 emitted by the illumination unit 102 and directed toward the scene, i.e., toward the FOV 120, and an inbound optical path (reception path RX) for directing light 206 received from the FOV 120 toward the sensing unit 106. For example, the LIDAR system 100 may employ bistatic architecture, sometimes referred to as biaxial architecture, in which the outbound light projected by the LIDAR system 100 (exiting) toward the scene and the inbound light reflected from the scene and received by the LIDAR system 100 (entering) pass through substantially different optical paths each comprising one or more distinct optical components, for example, a window, an aperture, a lens, a mirror, a beam splitter, and/or the like. In another example, shown in FIG. 2, the LIDAR system 100 may employ monostatic architecture, sometimes referred to as coaxial architecture, in which the outbound light 204 and the inbound light 206 may pass thorough substantially common or similar (same) optical paths sharing some and potentially most optical components. This means that the outbound light 204, directed toward the FOV 120 via the transmission optical path (TX), and the inbound light 206, directed from the FOV 120 toward one or more sensors of the LIDAR system 100 via the reception path (RX), may pass through the common optical path and thus through the shared optical component(s) deployed along the common optical path.

Optionally, one or more structures, configuration, and/or designs of the optical paths of the transmitted light 204 and the received light 206 may depend on a scanning mode of the LIDAR system 100.

The illumination unit 102 may include one or more light sources 112 configured to emit light in one or more light forms, formats, and/or modes, for example, laser light. For brevity, the term light source 112 is used herein after in singular form, however the light source 112 may include one or more light sources 112. The light source 112 may include, for example, a laser diode, a solid-state laser, a high-power laser, an edge emitting laser, a Vertical-Cavity Surface-Emitting Laser (VCSEL), an External Cavity Diode Laser (ECDL), A Distributed Bragg Reflector (DBR) laser, a laser array, and/or the like.

The light source 112 may be configured and/or operated, for example, by the processing unit 108, to emit light according to one or more light emission patterns defined by one or more light emission parameters, for example lighting technology (e.g., pulsed, CW, quasi-CW, etc.), scanning mode (e.g., spot scanning, line-scanning, flash scanning, etc.), light format (e.g., angular dispersion, polarization, etc.), spectral range (wavelength), energy/power (e.g., average power, maximum power, power intensity, instantaneous power, etc.), timing (e.g., pulse width (duration), pulse repetition rate, pulse sequence, pulse duty cycle, etc.), modulation (e.g., frequency, phase, amplitude, tones, etc.), and/or the like.

Optionally, the illumination unit 102 may further comprise one or more optical elements associated with one or more of the light source 112, for example, an aperture, a lens, a window, a light filter, a waveplate, a waveguide, a beam splitter, and/or the like for adjusting the light emitted by the light source 112, for example, collimating, focusing, polarizing, and/or the like the emitted light beams.

Moreover, the illumination unit 102 may include one or more light sources 112 configured to emit a plurality of light beams, typically simultaneously, such that each of the light beams illuminates a respective portion, section, and/or segment of the instantaneous FOV, for example, a respective portion 122 scanned by the LIDAR system 100 at any given moment. For example, assuming the LIDAR system 100 employs raster (flying spot) scanning, the light source(s) 112 may be configured to emit multiple light beams, for example, eight, for simultaneously scanning eight respective portions 122 of the FOV 120.

The scanning unit 104 may be configured to scan the FOV 120 and/or part thereof by projecting the light 204 emitted by the light source 112 toward the scene to illuminate the FOV 120 thus serving as a steering element on the outbound path of the LIDAR system 100, i.e., the transmission path TX, for directing the projected light 204 toward the scene, i.e., toward the FOV 120.

Optionally, the scanning unit 104 may be further used on the inbound path of the LIDAR system 100, i.e., the reception path RX, for directing toward the sensing unit 106 light (photons) 206 received from the FOV120 including light reflected from one or more objects in the FOV 120 illuminated by the light projected by the LIDAR system 100. The scanning unit 104 may optionally include one or more optical elements, for example, a lens, a mirror, a prism, a waveguide, a telephoto, a beam splitter, and/or the like configured to direct the reflected light 206 toward the sensing unit 106.

The scanning unit 104 may include one or more optical paths for transmitting the light 204 toward the FOV 120 and for receiving the received light 206. These optical paths may be separate for the outbound light 205 and the inbound light 206, for example, in a bi-axial architecture, or at least partly common and shared by the outbound light 205 and the inbound light 206, for example, in a monostatic architecture.

Moreover, since the illumination unit 102 may be configured to emit a plurality of light beams, for example, a beam array, on the transmission path TX (outbound path) of the LIDAR system 100, the scanning unit 104 may be configured to project the plurality of light beams for illuminating the FOV 120 and/or part thereof. Complementary, on the reception path RX (inbound path) of the LIDAR system 100, i.e., the scanning unit 104 may be configured to direct toward the sensing unit 106 received light 206 reflected from one or more objects in at least part of the FOV 120 illuminated by the plurality of light beams.

The scanning unit 104 may include one or more light deflectors 114 configured to deflect the light emitted by the light source 112 for illuminating the FOV 120 to scan it. The light deflector(s) 114 may include one or more scanning mechanism, module, devices, and/or elements configured to cause the emitted light to deviate from its original path, for example, a mirror, a prism, a controllable lens, a mechanical mirror, a mechanical scanning polygon, an active diffraction element (e.g., controllable LCD), a Risley prism, a waveguide, a non-mechanical-electro-optical beam steering (such as made, for example, by Vescent), a polarization grating (such as offered, for example, by Boulder Non-Linear Systems), an Optical Phase Array (OPA), and/or the like.

For example, the deflector(s) 114 may comprise one or more mechanical light deflectors, for example, a scanning polygon, interchangeable designated polygon scanner, having a plurality of reflective facets, for example, three, four, five, six and/or the like configured as mirrors and/or prisms to deflect light projected onto the facet(s) of the polygon. In another example, the deflector(s) 114 may comprise one or more Micro Electro-Mechanical Systems (MEMS) mirrors configured to move by actuation of a plurality of benders connected to the mirror.

In another example, the scanning unit 104 may include one or more non-mechanical deflectors 114, for example, a non-mechanical-electro-optical beam steering element such as, for example, an OPA which does not require moving components or internal movements for changing the deflection angles of the light but is rather controlled by steering a light projection angle of the light source 112 to a desired projection angle through phase manipulation of multiple light beams emitted by an array of light sources. It is noted that any discussion relating to moving or pivoting the light deflector(s) 114 is applicable, mutatis mutandis, to any type of light deflector 114, for example, non-mechanical deflectors.

At any given time, i.e., at any instantaneous point in time, during each scan cycle of the FOV 120 and/or part thereof by the LIDAR system 100, the deflector(s) 114 may be positioned in a respective instantaneous position defining a respective location, position, and/or orientation in space. In particular, each instantaneous position of the deflector(s) 114 may correspond to a respective instantaneous FOV, for example, one or more respective portions 122 of the FOV 120. This means that while positioned in each of a plurality of instantaneous positions during each scan cycle, the deflector(s) 114 may scan one or more respective portions 122 of the FOV 120, i.e., project light 204 toward the respective portion(s) 122, and optionally direct the received light (photons) 206 reflected from the respective portion(s) 122 toward the sensing unit 106.

The scanning unit 104 may be configured and/or operated to scan the FOV 120 and/or part thereof, on the outbound path and/or on the inbound path, at one or more scales of scanning. For example, the scanning unit 104 may be configured to scan the entire FOV 120. In another example the scanning unit 104 may be configured to scan one or more Regions of Interest (ROI) which cover only part of the FOV 120, for example, 10% or 25% of the FOV 120. Optionally, the scanning unit 104 may be operated to dynamically adjust the scanning scale, i.e., the scanned area, either between different scan cycles and/or during a scan cycle.

Optionally, the scanning unit 104 may further comprise one or more optical elements associated with the deflector(s) 114, for example, an aperture, a lens, a window, a light filter, a waveplate, a waveguide, a beam splitter, and/or the like for adjusting the light emitted by the light source 112 and/or for adjusting the light reflected from the scene, for example, collimate the projected light 204, focus the received light 206, filter the light, and/or the like.

Moreover, in one or more monostatic configurations, the LIDAR system 100 may comprise one or more asymmetrical deflectors configured to separate between the projected light 204 and the received light 206. For example, as seen in FIG. 2, an exemplary asymmetrical deflector 216 may be configured not to deflect the projected light 204 emitted by the illumination unit 102 and projected toward the FOV 120, while deflecting the received light 206 toward the sensing unit 106. Optionally, the asymmetrical deflector 216 may be configured to prevent received light 206 from hitting the illumination unit 102, and to direct all the received light 206 toward the sensing unit 106, thereby increasing detection sensitivity. The asymmetrical deflector 216 may comprise one or more optical elements having two sides capable of deflecting a beam of light hitting it from one side in a different direction than it deflects a beam of light hitting it from the second side. The asymmetrical deflector 216 may include, for example, a Polarization Beam Splitter (PBS). In another example, the asymmetrical deflector 216 may include an optical isolator configured to allow passage of light in only one direction.

The sensing unit 106 may include one or more sensors 116 configured to detect (receive, sample, and measure) light received from the surroundings of LIDAR system 100, specifically from the scene, i.e., the FOV 120, and generate reflection signals (interchangeably designated signal data, trace signals or trace data) indicative of light detected by the sensors 116 which may include light reflected from one or more objects in the FOV 120. For brevity, the term sensor 116 is used herein after in singular form, however the sensor 116 may include one or more sensors 116. Obviously, the sensor(s) 116 may be configured to be sensitive to light in the spectral range of the projected light, for example, laser light having a wavelength of, for example, 905 nanometer (nm), 1550 nm, and/or the like.

The sensor 116 may include one or more devices, components, and/or elements capable of measuring properties of electromagnetic waves, specifically light, impinging on their sensing surface (plane, area, region, etc.), for example, energy/power, intensity, frequency, phase, timing, duration, and/or the like and generate output signals indicative of the measured property(s). The sensor 116 may be configured and/or operated to sample incoming light according to one or more sampling modes, for example, continuous sampling, periodic sampling, sampling according to one or more timing schemes, and/or sampling instructions.

The sensing unit 106 may include a sensor array comprising a plurality of sensors 116 wherein each of the sensors 116 may correspond to a respective pixel mapping one or more portions of the FOV 120, for example, portions 122, scanned at a given moment of the scan cycle. For example, assuming the illumination unit 102 is configured to project a plurality of light beams, each of the plurality of sensors 116 of the sensor array may be associated with a respective one of the plurality of light beams, i.e., each sensor 116 may be configured to receive light reflected from one or more objects located in the portion (of the FOV 120 illuminated by its respective associated light beam. In another example, assuming the illumination unit 102 is configured to project a single elongated light beam (scan-line), the light reflected by one or more objects in the FOV 120 responsive to being illuminated by the elongated light beam may be divided to a plurality of portions each directed (transmitted) to a respective one of the plurality of sensors 116.

These pixels, relating to the light sensors 116 and thus interchangeably designated sensing pixels, may typically correspond to non-overlapping regions in the FOV 120. The sensing pixels should not be confused with the FOV pixels. For example, each FOV pixel, which may correspond to a respective portion 122, i.e., an instantaneous FOV scanned during a certain instantaneous point in time, may be mapped to one or more sensing pixels activated during the certain instantaneous point in time. However, typically, each FOV pixel (e.g., each portion 122), may be mapped to a respective sensing pixel activated during the certain instantaneous point in time during which the respective portion 122 is scanned (illuminated).

Each sensor 116 may include one or more light detectors of one or more types characterized by one or more parameters, for example, sensitivity, size, recovery time, cost, and/or the like. The sensor 116 may include a plurality of light detectors of a single type, or of multiple types selected according to their parameters to comply with one or more detection requirements of the LIDAR system 100, for example, detection reliability and/or accuracy over a span of ranges (e.g., maximum range, close range, etc.), dynamic range, temporal response, robustness against varying environmental conditions (e.g., temperature, rain, illumination, etc.), and/or the like.

Optionally, the sensing unit 106 may further comprise one or more optical elements, for example, an aperture, a lens, a window, a light filter, a waveplate, a waveguide, and/or the like for adjusting the light 206 received from the FOV 120 via the scanning unit 104, for example, focusing the received light 206, diffuse the received light 206 across the sensor 116, and/or the like.

For example, as seen in FIG. 2, each sensor 116, for example, a Silicon Photomultipliers (SiPM), a non-silicon photomultipliers, and/or the like, may include one or more light detectors each constructed from a plurality of detecting elements 220, for example, an Avalanche Photodiode (APD), Single Photon Avalanche Diode (SPAD), and/or the like. The plurality of detecting elements 220, each configured to cause an electric current to flow when light (photons) passes through an outer surface of the respective detecting element 220, may be disposed on a common silicon substrate for detecting photons received from the FOV 120. The detecting elements 220 of each light detector may be typically arranged as an array in one or more arrangements over a detection area of the sensor 116, for example, a rectangular arrangement as shown in FIG. 2, a square arrangement, an alternating rows arrangement, and/or the like. Optionally, the detecting elements 220 may be arranged in a plurality of regions, each corresponding to a light detector, which jointly cover the detection area of the sensor 116. Moreover, the plurality of detecting elements 220, for example, SPADs of each region, i.e., of each light detector, may have their outputs combined (.g., connected together) to produce a unified output signal of the respective light detector corresponding to the respective region.

The processing unit 108 may include one or more processors 118, homogenous or heterogeneous, comprising one or more processing nodes and/or cores optionally arranged for parallel processing, as clusters and/or as one or more multi core processor(s). The processor(s) 118 may execute one or more software modules such as, for example, a process, a script, an application, a (device) driver, an agent, a utility, a tool, an Operating System (OS), a plug-in, an add-on, and/or the like each comprising a plurality of program instructions stored in a non-transitory storage medium (program store) of the LIDAR system 100 and executed by one or more processors such as the processor(s) 118. The non-transitory storage medium supporting the processor(s) 118 for storing data and/or the program instructions (code) may comprise, for example, persistent memory (e.g., ROM, Flash, SSD, NVRAM, etc.), volatile memory (e.g., RAM component, cache, etc.), and/or the like. The processor(s) 118 may optionally include, integrate, utilize and/or facilitate one or more hardware elements (modules), for example, a circuit, a component, an Integrated Circuit (IC), an Application Specific Integrated Circuit (ASIC), a Field Programmable Gate Array (FPGA), a Digital Signals Processor (DSP), a Graphic Processing Unit (GPU), an Artificial Intelligence (AI) accelerator and/or the like.

The processor(s) 118 may therefore execute one or more functional modules implemented using one or more software modules, one or more of the hardware modules and/or combination thereof. For example, the processor(s) 118 may execute one or more functional modules to control functionality of the LIDAR system 100, for example, configuration, operation, coordination, and/or the like of one or more of the functional units of the LIDAR system 100, for example, the illumination unit 102, the scanning unit 104, and/or the sensing unit 106. The processor 118 may communicate with the functional units of the LIDAR system 100 via one or more channels, interconnects, and/or networks deployed in the LIDAR system 100, for example, a bus (e.g., PCIe, etc.), a switch fabric, a network, a vehicle network, and/or the like.

While the processor(s) 118 may comprise multiple processors, and/or processing devices, for brevity and clarity, the processor(s) 118 are designated in the singular form hereinafter, i.e., the processor 118. It should also be noted that wherever the processor 118 is described to perform or configured to perform functional operations, actions, tasks, and/or the like, these are perform by the processor 118 executing one or more functional modules utilized through software, hardware, and/or a combination thereof.

For example, the processor 118 may be configured to control the scanning unit 104 for scanning the environment of the LIDAR system 100 according to one or more scanning schemes and/or scanning parameters, for example, extent (e.g., angular extent) of the FOV 120, extent of one or more ROIs within the FOV 120, maximal range within the FOV 120, maximal range within each ROI, maximal range within each region of non-interest, resolution (e.g., vertical angular resolution, horizontal angular resolution, etc.) within the FOV 120, resolution within each ROI, resolution within each region of non-interest, scanning mode (e.g., raster, alternating pixels, etc.), scanning speed, scanning cycle timing (e.g., cycle time, frame rate), and/or the like.

In another example, the processor 118 may be configured to coordinate operation of the light source 112 with movement and/or operation of the deflector(s) 114 for scanning the FOV 120 and/or part thereof. In another example, the processor 118 may be configured to configure and/or operate the light source 112 to project light according to one or more light emission patterns. In another example, the processor 118 may be configured to coordinate operation of the sensor 116 with movement and/or operation of the deflector(s) 114 to activate one or more selected sensor 116 and/or pixels according to the scanned portion of the FOV 120.

In another example, the processor 118 may be configured to receive the signal data (reflection signals, trace data) generated by the sensor 116 which are indicative of light received from the FOV 102 and detected by the sensor 116 including light reflected from one or more objects in the scanned FOV 120 and/or part thereof which are illuminated by projected 204. In another example, the processor 118 may be configured to analyze the signal data received from the sensor 116 in order to detect one or more objects, conditions, and/or the like in the environment of the LIDAR system 100, specifically in the scanned FOV 120 and/or part thereof. Analyzing the signal data indicative of the received (reflected) light 206 may include, for example, determining a ToF of the reflected light 206, based on timing of output of the signal data, specifically with respect to transmission timing of the projected light 204, for example, light pulses, corresponding to the respective reflected light 206. In another example, analyzing the signal data may include determining a power of the reflected light 206, for example, average power across an entire return pulse, and a photon distribution/signal may be determined over the return pulse period (“pulse shape”).

Based on analysis of the signal data (reflection signals) received from the sensor 116 which is indicative of the light reflected from object(s) in the scene, specifically in the FOV 120, the processor 118 may extract depth data relating to the scene and may derive and/or determine one or more attributes of the detected object(s). Such object attributes may include, for example, a distance between the LIDAR system 100 and the detected object, a spatial location of the detected object, for example, with respect to one or more coordinate systems (e.g., Cartesian (X, Y, Z), Polar (r, θ, φ), etc.), a velocity of the detected object, a reflectivity of the detected object, and/or the like. Based on the signal data coupled with the scanning scheme of the scanning unit 104, i.e., the instantaneous positioning, orientation, and/or activation of the deflector 114, the processor 118 may determine the portion 122 of the FOV 120 to which the signal data relates and may map the objects detected in the scene, i.e., determine a direction to the detected object(s), a position, an azimuth, an elevation, and/or the like.

The processor 118 may further combine, join, merge, fuse, and/or otherwise aggregate information, for example, signal data, depth data, and/or the like pertaining to different objects, and/or different features of objects detected in the scene. For example, the processor 118 may be configured to generate and/or reconstruct one or more 3D models (interchangeably designated depth maps herein) of the environment of the LIDAR system 100, i.e., of objects scanned in the scene included in the FOV 120 and/or part thereof. The data resolution associated with the depth map representation(s) of the FOV 120 which may depend on the operational parameters of the LIDAR system 100 which may be defined by horizontal and/or vertical resolution, for example, 0.05°×0.05°, 0.05°×0.1°, 0.1°×0.1°, 0.3°×0.3°, 0.1°×0.5° of the FOV 120, and/or the like.

The processor 118 may generate depth map(s) in one or more forms, formats, and/or types, for example, a point cloud model, a polygon mesh, a depth image holding depth information for each pixel of a 2D image and/or array, and/or any other type of 3D model of the scene. A point cloud model may include a set of data points located spatially which represent the scanned scene in some coordinate system, i.e., having an identifiable locations in a space described by a coordinate system, for example, Cartesian coordinates, Polar coordinates, and/or the like. Each point in the point cloud may be a dimensionless, or a miniature cellular space whose location may be described by the point cloud using the set of coordinates.

The point cloud may further include additional information for one or more and optionally all of its points, for example, reflectivity (e.g., energy of reflected light, etc.), ambient light information, color information, angle information, and/or the like. A polygon mesh or triangle mesh may include, among other data, a set of vertices, edges and faces that define the shape of one or more 3D objects (polyhedral object) detected in the scanned scene. The processor 118 may further generate a sequence of depth maps over time, i.e., a temporal sequence of depth maps, for example, each depth map in the sequence may be associated with a respective scanning cycle (frame). In another example, the processor 118 may update one or more depth maps over time based on depth data received and analyzed in each frame.

Optionally, the processor 118 may control the light projection scheme of the light emitted to the environment of the LIDAR system 100, for example, adapt, and/or adjust the light emission pattern and/or the scanning pattern, to improve mapping of the environment of the LIDAR system 100. For example, the processor 118 may control the light projection scheme to illuminate different portions 122 across the FOV 120 according to different illumination parameters in order to differentiate between light reflected from the different portions 122. In another example, the processor 118 may apply a first light projection scheme, for example, increased resolution scanning, for one or more first areas in the FOV 120, for example, a ROI and a second light projection scheme, for example, reduced resolution scanning, for one or more other parts of the FOV 120 (non ROI). In another example, the processor 118 may adjust the light projection scheme between scanning cycles (frames) such that a different light projection scheme may be applied in different frames. In another example, the processor 118 may adjust the light projection scheme based on detection of reflected light, either during the same scanning cycle (e.g., the initial emission) and/or between different frames (e.g., successive frames), thus making the LIDAR system 100 extremely dynamic.

Optionally, the LIDAR system 100 may include a communication interface 214 comprising one or more wired and/or wireless, interconnection, communication channels, and/or network links, for example, PCIe, Local Area Network (LAN), automotive Ethernet, Gigabit Multimedia Serial Link (GMSL), InfiniBand, wireless LAN (WLAN), cellular network, and/or the like. Via the communication interface 214, the LIDAR system 100, specifically the processor 118 may transfer data and/or communicate with one or more external systems, for example, a host system 210, interchangeable designated host herein.

The host 210 may include any computing environment comprising one or more processors 218 such as the processor 118 which may communicate, interface, and/or otherwise interact with the LIDAR system 100 via the communication interface 214. For example, the host 210 may include one or more systems deployed, mounted, and/or located in the vehicle 110 such as, for example, an ADAS, a vehicle control system, a vehicle safety system, a client device (e.g., laptop, smartphone, etc.), and/or the like. In another example, the host 210 may include one or more remote systems, for example, a security system, a surveillance system, a traffic control system, a smart city system, an urban modelling system, and/or other systems configured to collect data from vehicles in order to monitor their surroundings. In another example, the host 210 may include one or more remote cloud systems, services, and/or platforms configured to collect data from vehicles 110 for one or more monitoring, analysis, and/or control applications. In another example, the host 210 may include one or more external systems, for example, a testing system, a monitoring system, a calibration system, and/or the like.

The host 210 may be configured to interact and communicate with the LIDAR system 100 for one or more purposes, operations, and/or actions, for example, configure the LIDAR system 100, control operation of the LIDAR system 100, analyze data received from the LIDAR system 100, and/or the like. For example, the host 210 may generate one or more depth maps and/or 3D models based on signal data (reflection signals, trace data), and/or depth data received from the LIDAR system 100. In another example, the host 210 may configure one or more operation modes, and/or parameters of the LIDAR system 100, for example, define a ROI, define an illumination pattern, define a scanning pattern, define activation pattern of the sensor 116, and/or the like. In another example, the host 210 may dynamically adjust in real-time one or more operation modes and/or parameters of the LIDAR system 100.

Optionally, execution of one or more processing tasks may be distributed between the host 210 and the processor 118 of the LIDAR system 100. For example, generation of one or more depth maps, for example, a point cloud representing the environment of the LIDAR system 100 and/or part thereof, may be distributed between the host 210, specifically the processor(s) 218 and the processor 118, such that the point cloud may be generated jointly by processor 118 and processor(s) 218, each executing part of the point cloud generation task.

According to some embodiments disclosed herein, a LIDAR system such as the LIDAR system 100 may further comprise one or more tunable optical filters dynamically controlled and/or operated according to ambient light conditions of the external environment of the LIDAR system 100 in order to control the light 206, specifically ambient light received from the FOV 120 and directed to the sensor 116.

As described herein before, while primarily used for detecting objects based on light projected by the LIDAR system 100 and reflected from objects in the FOV 120, the LIDAR system 100 may be also used for constructing one or more images of the FOV and/or part thereof based on ambient light received from the FOV, i.e., light that is unrelated to the light projected by the LIDAR system 100, for example, sunlight, light projected by external light sources, and/or the like. Specifically, these images may be constructed using signal data generated by the sensor(s) 116 which is indicative of the ambient light detected by the sensor 116.

However, detection and measurement of the ambient light by the sensor 116 may be degraded due to one or more ambient light conditions in the external environment of the LIDAR system 100. For example, under low ambient light conditions, for example, at night, in a tunnel, in a closed parking lot, and/or the like, the intensity (level, amount, photon count) of ambient light detected by the sensor 116 may be significantly reduced which may result in reduced quality images. In another example, under high ambient light conditions, for example, during bright sunny days, in an IR intense environment, and/or the like, the sensor 116 may detect high intensity ambient light which may degrade quality of the images due to one or more effects, for example, optical noise, saturation of the sensor 116, reduced dynamic range of the sensor 116, and/or the like.

Therefore, in order to control the intensity of ambient light received from the FOV 120 and detected by the sensor 116, one or more tunable optical filters, positioned such that light received by the sensor 116 from the FOV 120 is transmitted (passes) via the tunable optical filters, may be dynamically operated according to one or more of the ambient light conditions detected in the external environment. For brevity, an optical filter is designated herein after in singular form but may include one or more optical filters. In particular, the tunable optical filter may be dynamically operated, according to ambient light conditions currently present in the external environment, to transmit (transfer) sufficient ambient light to the sensor 116 such that the signal data generated accordingly by the sensor 116 may be used for constructing increased quality images of the FOV and/or part thereof.

Moreover, while ensuring sufficient ambient light to be detected by the sensor 116, the tunable optical filter may be operated to reduce the level of optical noise induced by the ambient light received from the FOV 120 and detected by the sensor 116, and/or to prevent saturation of the sensor 116 such that the sensor 116 may generate accurate, reliable, and/or robust signal data which may be used for constructing increased quality images of the FOV and/or part thereof.

The tunable optical filter, typically implementing a Band Pass Filter (BPF), may have a dynamically adjustable passband such that a passband width (bandwidth) of the tunable optical filter's may be adjusted according to one or more of the identified ambient light conditions to transfer (transit) sufficient ambient light to the sensor 116, and optionally reduce optical noise.

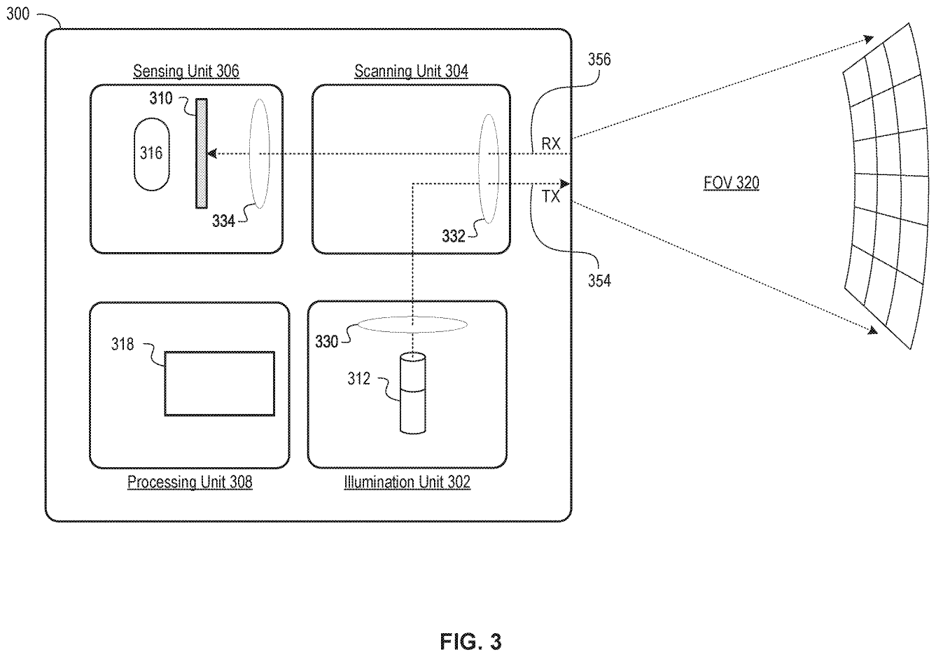

Reference is also made to FIG. 3, which is a schematic illustration of exemplary LIDAR system comprising one or more tunable optical filters positioned for transmitting light received from a FOV of the LIDAR system to one or more sensors of the LIDAR system, in accordance with embodiments of the present disclosure.

An exemplary LIDAR system 300 such as the LIDAR system 100, configured to scan a FOV 320 such as the FOV 120, may include an illumination unit 302 such as the illumination unit 102, a scanning unit 304 such as the scanning unit 104, a sensing unit 306 such as the sensing unit 106, and a processing unit 308 such as the processing unit 108.

The illumination unit 302 may comprise one or more light sources 312 such as the light source 112 configured to emit one or more light beams, for example, laser beams, for scanning the FOV 320 and/or part thereof. For brevity, the light source 312 is used herein after in singular form, however the light source 312 may include one or more light sources 312.

The sensing unit 306 may comprise one or more sensors 316 such as the sensor 116, each configured to detect light 356 received from the FOV 320 such as the received light 206 and generate signal data accordingly indicative of the received light 356 detected by the sensor 316. For brevity, sensor 316 is designated herein after in singular form but may include one or more sensors 316. As described herein before, the sensor 316 may be configured to be sensitive to light in the spectral range of the projected light 354, for example, laser light having a wavelength of, for example, 905 nanometer (nm), 1550nm, and/or the like. However, in order to collect ambient light which is unrelated to the projected light 354 which may thus be distributed across one or more extended and/or other spectral regions (ranges), the sensor 316 may be further configured to be also sensitive to light in these spectral range(s). For example, the sensor 316 may be configured to detect light in an extended spectral range comprising the wavelength of the projected light 354, for example, 880-920 nm, 800-950 nm, 750-1000 nm, 600-1000 nm, 350-1000 nm, and/or the like.

The scanning unit 304 may be configured to project the light emitted by the light source 312 toward the FOV 320 for scanning the FOV 320, i.e., illuminate the FOV 320 and/or part thereof with projected light 354 (via transmission path TX). Optionally, the scanning unit 304 may be further configured to direct toward the sensor 316 (via reception path RX) received light 356 reflected from one or more objects in the FOV 320.

As described herein before with respect to the LIDAR system 100, the LIDAR system 300 may employ one or more scanning technologies, architectures, and/or algorithms for detecting objects in the FOV 320 and their attributes (e.g., position, distance, velocity, reflectivity, size, shape, etc.). For example, the LIDAR 300 may be a pulsed LIDAR (also known as ToF LIDAR) which projects (transmits) light pulses 354 and measures the Time of Flight (ToF) of the light 356 on its return path from the LIDAR system 300 to an object in the FOV 320 and back to the LIDAR system 300 using signal data generated by the sensor 316 which is indictive of reflected light detected by the sensor 316. In another example, the LIDAR system 300 may be a Continuous Wave (CW) based LIDAR, also known as coherent LIDAR, in which the light 354 projected toward the FOV 320 may comprise modulated CW light, for example, a Frequency Modulated CW (FMCW), a phase modulated CW, an amplitude modulated CW, a Mult-Tone CW (MTCW), and/or the like. The coherent LIDAR system 300 may detect objects and one or more of their attributes based on differences in one or more light signal parameters identified in the light 356 reflected from the FOV 320 compared to the light 354 projected by the LIDAR system 300 toward the FOV 320, for example, frequency, phase, amplitude, and/or a combination thereof.

The illumination unit 302, specifically the light source 312, the scanning unit 304, and optionally the sensor 316 may be therefore configured, and/or structured according to the scanning technologies, architecture, and/or algorithms of the LIDAR system 300. For example, in case the LIDAR system is a ToF LIDAR, the light source 312 may be configured to emit light pulses which may be projected by the scanning unit 304 toward the FOV 320. In such case, the scanning unit 304 may typically include one or more mechanical deflectors, for example, a mechanical mirror, a mechanical scanning polygon, and/or the like which is pivotable in one or more axes for deflecting the light 354 emitted by the light source 312 toward the FOV 320. In another example, in case the LIDAR system is a coherent LIDAR, the light source 312 may be configured to emit a CW light signal light which may be projected by the scanning unit 304 toward the FOV 320. In such case, the scanning unit 304 may typically include a non-mechanical scanner, for example, a waveguide, an array of waveguides, an OPA, and/or the like optionally coupled with one or more mechanical deflectors for transmitting the light 354 toward the FOV 320.

As described for the illumination unit 102, the illumination unit 302 may optionally include one or more optical elements 330, for example, an aperture, a lens, a window, a light filter, a waveplate, a waveguide, and/or the like for adjusting the light emitted by the light source 312, for example, collimating, focusing, polarizing, and/or the like the emitted light beams. Also as described for the scanning unit 104, the scanning unit 304 may optionally comprise one or more such optical elements 332, for adjusting the light 354 emitted by the light source 312 and directed toward the FOV 320 and/or for adjusting the light 356 reflected from the scene, i.e., from the FOV 320, for example, collimate the projected light 354, focus the received light 356, and/or the like. Additionally and/or alternatively, the sensing unit 306 may comprise one or more optical elements 334 such as the optical elements 330 for adjusting the light 356 received from the FOV 320 (scene), for example, focus the received light 356 on a sensing plane of the sensor 316, distribute the received light 356 across the sensor 316, polarize the received light 356, and/or the like.

The processing unit 308 may comprise one or more processors 318 such as the processor 118, designated in the singular from processor 318 for brevity, configured to execute one or more operations, actions, tasks, and/or the like as described herein before.

The LIDAR system 300 may further include one or more tunable optical filters 310 positioned, and/or configured such that light 356 received from the FOV 320 is directed to the sensor 316 via the tunable optical filter(s) 310. In other words, the one or more tunable optical filter 310 may be positioned, placed, and/or deployed within the reception (inbound) optical path (RX) of the LIDAR system 300 downstream from the sensors 316, i.e., between the sensor 316 and the FOV 320 such that the light 356 received by the sensor 316 from the FOV 320 is transferred (transmitted, passed) via the tunable optical filters 310. For brevity, tunable optical filter 310 is designated hereinafter in singular form but may include one or more tunable optical filters 310.

It should be noted that while the tunable optical filter 310 is illustrated to be positioned (deployed) in the inbound optical path (RX) between the sensor 316 and the optical element(s) 334, this should not be construed as limiting. If one or more such optical elements 334 are deployed in the LIDAR system 300, one or more other deployments of the tunable optical filter 310 with respect to the optical element(s) 334 may be applied as may be apparent to a person skilled in the art. For example, one or more optical elements 334 may be positioned in the inbound optical path (RX) between the sensor 316 and the tunable optical filter 310. In another example, the tunable optical filter 310 may be positioned in the inbound optical path (RX) between optical elements 334.

The tunable optical filter 310 may comprise a Band Pass Filter (BPF) having a dynamically adjustable passband such that the tunable optical filter 310 may be operated, for example, by the processor 318, to adjust a width (bandwidth) of their passband in order to control the spectral range of light 356 transmitted toward the sensor 316 via the tunable optical filter 310 and thus control the intensity of light received and detected by the sensor 316.

As described herein before, the tunable optical filter 310 may comprise a BPF having a dynamically adjustable passband such that the tunable optical filter 310 may be operated to adjust the width of its passband.

However, in order to ensure proper and efficient object detection of the LIDAR system 300, the tunable optical filter 310 may be configured such that its passband includes the wavelength of the light 354 emitted by the light source 312 and projected by the LIDAR system 300 to scan the FOV 320 and/or part thereof. For example, assuming the light source 312 are configured to emit light, for example, one or more laser light beams a certain wavelength, for example, 905 nm, 1550 nm, and/or the like. In such case, assuming the certain wavelength of the projected light 354 is 905 nm for example, the tunable optical filter 310 may be configured to have its passband include the certain wavelength, for example, 895-915 nm, 800-920 nm, 600-920 nm, 800-1000 nm, and/or the like.

As described herein before, while sensitive to light in the spectral range of the projected light, for example, 905 nm, 1550 nm, and/or the like, the sensor 116 may be further configured to also detect and measure ambient light in the spectral range(s) targeted by the LIDAR system 300 and thus transmitted (transferred) via the tunable optical filter 310, for example, 450-700 nm, 300-750 nm, and/or the like.

Moreover, the optical elements deployed and or positioned in the reception optical path (RX), for example, the optical element(s) 332 and/or the optical element(s) 334 may be also configured according to the wavelengths of the received light 356, specifically received light 356 corresponding to the projected light 354 and received light 356 comprising ambient light, specifically ambient light targeted by the LIDAR system 300, i.e., ambient light transmitted via the tunable optical filter 310, for example, light in a spectral region, 450-700 nm, 300-750 nm, and/or the like. As such, the optical element(s) 332 and/or 334 may be configured to effectively adjust, transform and/or otherwise manipulate light in one or more spectral ranges, for example, 400-100 0nm, 450-750 nm and 900-910, and/or the like.

The tunable optical filter 310 may use one or more technologies, architectures, designs, and/or structures for implementing one or more light filtering configurations, and/or operation modes, by adjusting the width of the tunable optical filter 310 passband.

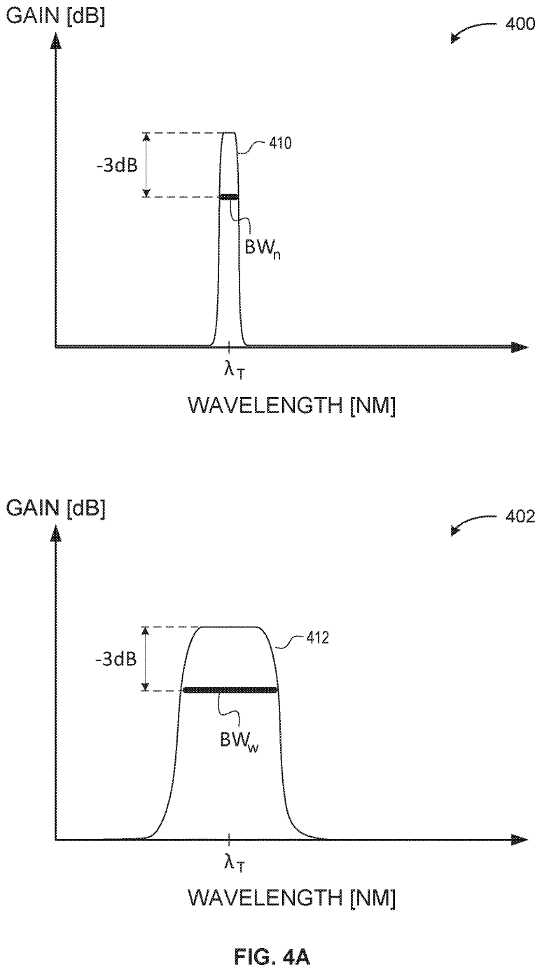

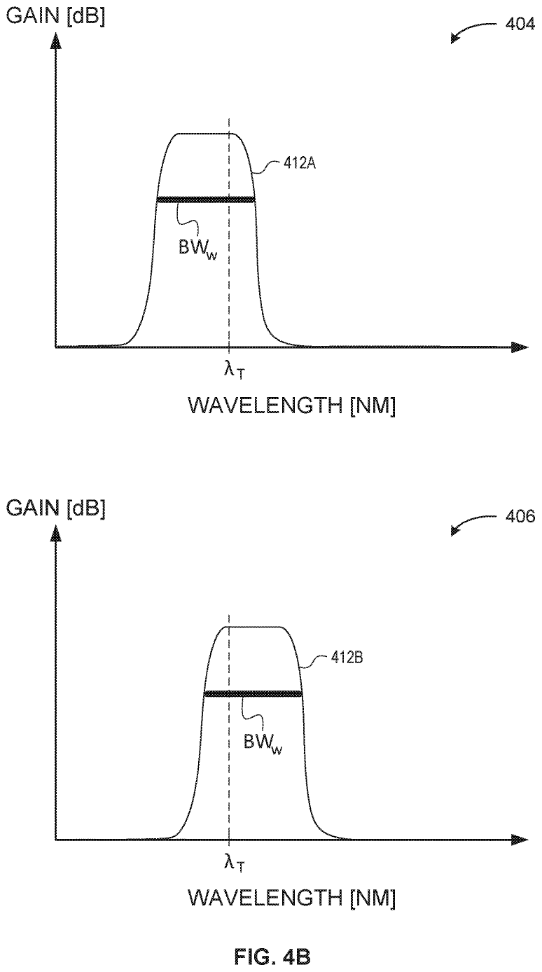

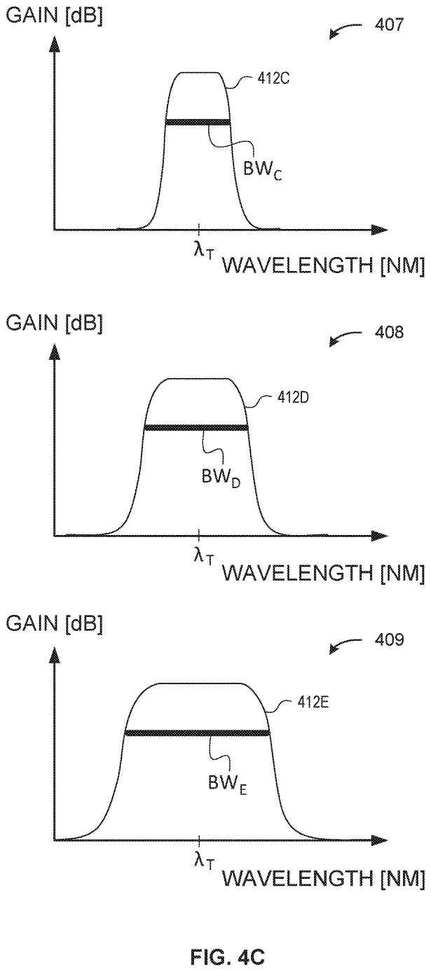

Reference is now made to FIG. 4A, FIG. 4B, and FIG. 4C, which depict graph charts illustrating transfer functions of exemplary tunable optical filters positioned in a LIDAR system for transmitting light received from a FOV of the LIDAR system to one or more sensors of the LIDAR system, in accordance with embodiments of the present disclosure.

An exemplary tunable optical filter such as the tunable optical filter 310, positioned and/or configured to transmit light received from a FOV such as the FOV 320 to one or more sensors such as the sensor 316 of a LIDAR system such as the LIDAR system 300, may be operable to dynamically adjust the width of its passband to one of two or more state, specifically a narrow passband state for transmitting reduced intensity light (level, amount, photon count) to the sensor 316, and a wide passband state for transmitting increased intensity light to the sensor 316.

As illustrated in graph chart 400, the first state may be expressed by transfer function graph 410 which has a narrow passband (bandwidth) BWₙ, while the second state may be expressed by transfer function graph 412 shown in graph chart 402 which has a wide passband BW_{w}.

As illustrated in graph charts 400 and 402, in both states, the passband of the first exemplary tunable optical filter comprises a wavelength λ_{T} which is the wavelength of the light projected by the LIDAR system 300 for scanning the FOV 320 so that projected light such as projected light 354 which is reflected from one or more objects in the FOV 320, i.e., reflected light 356, may pass through the first exemplary tunable optical filter and be transmitted to the sensor 316. This essential since object detection functionality of the LIDAR system 300 is based on detection of the reflected light 356.

While shown to be centered around the projected light wavelength λ_{T}, the passband of the first exemplary tunable optical filter may be optionally adjusted and/or located, specifically when adjusted to its second state, i.e., wide passband BW_{w}, such that the passband includes the wavelength λ_{T} of the projected light 354, but not necessarily centered around the wavelength λ_{T} but rather offset with respect to the wavelength λ_{T}. For example, as illustrated in graph chart 404 showing a transfer function graph 412A of an exemplary tunable optical filter, the passband of the tunable optical filter may be adjusted to be offset from the wavelength λ_{T}, for example, offset towards lower wavelength, specifically when adjusted to the second state, i.e., wide passband BW_{w}, such that higher intensity of light in higher spectral range (e.g., visible light spectrum) may be transferred via the exemplary tunable optical filter. In another example, as illustrated in graph chart 406 illustrating a transfer function graph 412A of another exemplary tunable optical filter, the passband of the tunable optical filter may be adjusted to be offset towards higher wavelength, specifically when adjusted to the second state, i.e., wide passband BW_{w}, such that higher intensity of light in lower spectral range (e.g., IR spectrum) may be transferred via the exemplary tunable optical filter.

Optionally, the tunable optical filter 310 may be operable to dynamically adjust the width of its passband to a plurality of widths of the tunable optical filter's passband. For example, an exemplary tunable optical filter such as the tunable optical filter 310 may be operable to adjust its passband within a predefined width range. For example, assuming the light emitted by the light source 312 and projected by the LIDAR system 300, for example, laser light having a certain wavelength, for example, 905 nm, 1550 nm, and/or the like, the exemplary tunable optical filter(s) may be operable to adjust the width of its passband within a width range of comprising the certain wavelength, for example, 500-1100 nm, or 1000-1700 nm respectively.

In another example, the tunable optical filter 310 may be operable to dynamically select the width of the passband from a plurality of discrete width values. For example, assuming the light projected by the LIDAR system 300 has a certain wavelength, for example, 905nm, the exemplary tunable optical filter may be operable to adjust the width to a certain one of a plurality of widths, for example, 900-910 nm, 850-950 nm, 750-1050 nm, 600-1100 nm, and/or the like.

Illustrations 407, 408, and 409 show transfer function graphs of a plurality of passband width values of an exemplary tunable optical filter such as the tunable optical filter 310 which may be operable to have its passband width adjusted to a plurality of width values within a range or selected from a plurality of width values. For example, illustration 407 shows a transfer function graph 412C of the exemplary tunable optical filter operated to a first state by adjusting its passband to have a first width BW_{C} such that the exemplary tunable optical filter may pass light in the spectral range corresponding to the first width BW_{C}. Illustration 408 shows a transfer function graph 412D of the exemplary tunable optical filter operated to a second state by adjusting its passband to have a second width BW_{D} larger than the first width BW_{C}. As such, in the second state, the exemplary tunable optical filter may transfer (pass) light in an increased spectral range compared to the first state which may increase intensity of the transferred light. Illustration 409 shows a transfer function graph 412E of the exemplary tunable optical filter operated to a third state by adjusting its passband to have a third width BW_{E} larger than the second width BW_{D}. As such, in the third state, the exemplary tunable optical filter may transfer light in an even more increased spectral range compared to the first state and the second state which may further increase intensity of the transferred light.

Optionally, the passband of the tunable optical filter 310 may be configured, adjusted, and/or operated to adjust the center wavelength of the passband such that the passband includes the wavelength of the light 354 projected by the LIDAR system 300. Adjusting the center wavelength of the passband of the tunable optical filter 310 to include the wavelength of the projected light 354 and thus tracking the wavelength of the projected light 354 may ensure that the light 356 reflected from objects in the FOV 320 which are illuminated with the projected light 354 is not filtered out and blocked by the tunable optical filter 310. This may significantly improve object detection performance of the LIDAR system 300 since in case of deviations in the wavelength of the projected light 354 (induced by temperature changes for example), the center wavelength of the passband of the tunable optical filter 310 may be adjusted according to the detected deviation thus ensuring no reflected light 356 is blocked. In another example, the LIDAR system 300 may be operated to switch between operation modes in terms of the wavelength of the projected light 354, for example, between 905 nm and 915 nm. In such case, the center wavelength of the passband of the tunable optical filter 310 may be adjusted accordingly.

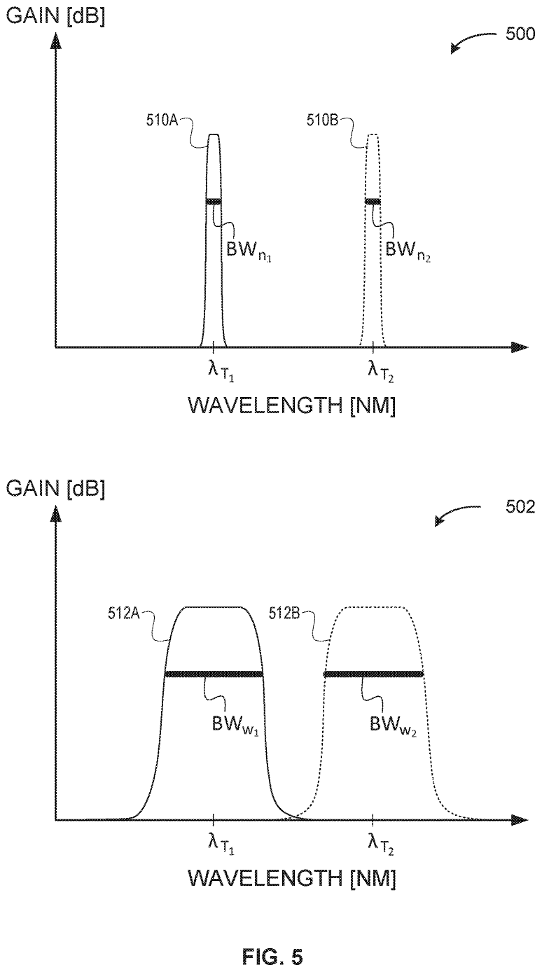

Reference is now made to FIG. 5, which depicts graph charts illustrating transfer functions of exemplary tunable optical filters having a moveable and adjustable passband which is positioned in a LIDAR system for transmitting light received from a FOV of the LIDAR system to one or more sensors of the LIDAR system, in accordance with embodiments of the present disclosure.

An exemplary tunable optical filter such as the tunable optical filter 310, positioned and/or configured to transmit light received from a FOV such as the FOV 320 to one or more sensors such as the sensor 316 of a LIDAR system such as the LIDAR system 300, may be operable to dynamically adjust the width of its passband to one of two or more state, specifically a narrow passband state for transmitting light with reduced intensity to the sensor 316, and a wide passband state for transmitting light with increased intensity to the sensor 316.

The exemplary tunable optical filter 310 may be further operated to adjust the center wavelength of its passband, in particular according to a wavelength λ_{T} of the light 354 projected by the LIDAR system 300. As illustrated in graph charts 500 and 502, the exemplary tunable optical filter 310 may be operated to adjust the center wavelength of its passband and track the wavelength λ_{T} in all states of the tunable optical filter 310, for example, the narrow passband state (graph chart 500) and the wide passband state (graph chart 502).

For example, in the first state corresponding to the narrow passband BWₙ (graph chart 500), assuming the wavelength of the projected light 354 is λ_{T}_{₁}, the exemplary tunable optical filter 310 may be operated to adjust the width of its passband to the narrow passband BWₙ_{₁} and further operated to adjust the narrow passband BWₙ_{₁}to include the wavelength λ_{T}_{₁} of the projected light 354, typically, at the center of the passband BW_{w}_{₁} as expressed by transfer function 510A. However, in case the wavelength of the projected light 354 is λ_{T}_{₂}, the exemplary tunable optical filter 310 may be operated to adjust the width of its passband to a narrow passband BWₙ_{₂} around the wavelength λ_{T}_{₂}, typically such that the wavelength λ_{T}_{₂} is at the center of the passband BWₙ_{₂} as expressed by transfer function 510B.

Complementary, in the second state corresponding to the wide passband BW_{w}, as illustrated in graph chart 502, in case the wavelength of the projected light 354 is λ_{T}_{₁}, the exemplary tunable optical filter 310 may be operated to adjust the width of its passband to a wide passband BW_{w}_{₁}and further operated to adjust the wide passband BW_{w}_{₁}to include the wavelength λ_{T}_{₁} of the projected light 354, typically, at the center of the passband BW_{w}_{₁} as expressed by transfer function 512A. However, in case the wavelength of the projected light 354 is detected to be λ_{T}_{₂}, the exemplary tunable optical filter 310 may be operated to adjust the width of its passband to a wide passband BWₙ_{₂} around the wavelength λ_{T}_{₂}, typically, such that the wavelength λ_{T}_{₂} is at the center of the passband BWₙ_{₂} as expressed by transfer function 512B.

Adjusting the passband of the tunable optical filter 310 to track the wavelength λ_{T}_{₁} of the projected light 354 may enable adapting to wavelength changes in the projected light 354 and thus allow efficient transmission of reflections of the projected light 354 from the FOV 320 to the sensor 316, i.e., more reflected light may be transmitted to the sensor 316 which may significantly improve object detection performance of the LIDAR system 300, in particular for the corresponding to the narrow passband BWₙ. Changes in the wavelength of the projected light 354 may be either an intentional change as an operational feature of the LIDAR system 300, and/or deviations due to laser instability, temperature change, and/or the like. Means for detecting, determining, and/or computing the wavelength of the projected light 354 are known in the art and are beyond the scope of this disclosure.

Additionally and/or alternatively, the tunable optical filter 310 may be implemented in combination with one or more fixed optical filters having one or more fixed passbands, i.e., a multiband filter. For example, the fixed optical filter(s) may include two fixed passbands, a first fixed passband which may be significantly narrow and centered around the wavelength of the projected light 354 and a second fixed passband configured to transfer a spectral region corresponding to (comprising) the visible light spectrum (400-700 nm) and/or part thereof. The second fixed passband may include or exclude the wavelength of the projected light 354. The fixed optical filter may be positioned in the inbound optical path (RX) of the reflected light 356 trough which the reflected light 356 is received from the FOV 320 and directed toward the sensor 316, for example, a filtering coating applied on the sensing surface of the sensor 316, a filter device deployed on top the sensor 316, and/or the like.

In such embodiments, the tunable optical filter 310, which is also positioned in the inbound optical path (RX), may be tuned to transmit (transfer) light to the sensor 316 in the wavelength corresponding to the first and/or second passbands of the fixed optical filter. In particular, the tunable optical filter 310 may have an adjustable passband which may be switched between a plurality of states, for example, a first state in which the passband of the tunable optical filter 310 corresponds to the first passband of the fixed optical filter, and a second state in which the passband of the tunable optical filter 310 corresponds to the first and second passband of the fixed optical filter.

For example, assuming the wavelength of the project light 354 is 905 nm. Further assuming that the sensor 316 is sensitive to light in one or more other wavelength ranges (spectral regions), specifically visible light wavelength range, for example, 400-700 nm, 300-750 nm, and/or the like. In such case, the fixed optical filter may be configured to have two fixed passbands, a first narrow passband around the wavelength of the projected light 354, for example, 895-915 nm, and a second passband configured to transfer a wider spectral region away from the wavelength of the projected light 354, for example, 300-750 nm.

In such case, the adjustable passband of the tunable optical filter 310 may be adjusted to pass, filter and/or block received light 356 in one or more wavelength ranges (spectral regions) corresponding to the fixed passbands of the fixed optical filter. For example, in a first state of the tunable optical filter 310, the passband of the tunable optical filter 310 may be adjusted to correspond to the narrow fixed passband and pass only light in wavelengths of 895-915 nm thus transferring a reduced amount (intensity) of light to the sensor 316. In a second state of the tunable optical filter 310, the passband of the tunable optical filter 310 may be adjusted to correspond to both the narrow fixed passband around the wavelength of the projected light 354 and the passband away from the wavelength of the projected light 354. In the second state, the tunable optical filter may therefore pass light in wavelengths of 895-915 nm as well as light in the spectral region of 300-750 nm and/or part thereof thus transmitting increased intensity light to the sensor 316 compared to the first state.

Optionally, in the second state, in order to transfer an increased light level, the tunable optical filter 310 may be operated to transfer all light, i.e., not filter out any wavelength of the received light 356 such that filtering of the light transmitted to the sensor 316 is only done by the fixed optical filter associated with the sensor 316. For example, the tunable optical filter(s) 310 may be removed from the inbound optical path (RX) of the reflected light 356.

Optionally, the fixed optical filter associated with the sensor 316 may be selected, adapted, and/or configured to have its first and second fixed handpasses substantially separated from each other, for example, by 200 nm, 300 nm, and/or the like. This may enable the use of reduced accuracy tunable optical filter 310 since the adjustable passband of the tunable optical filter 310 may exceed the boundary(s) of one of the fixed passbands of the fixed optical filter without crossing over to the second fixed passband of the fixed optical filter. Using a reduced accuracy tunable optical filter 310 may significantly reduced complexity, cost, and/or deployment complexity of the tunable optical filter 310.

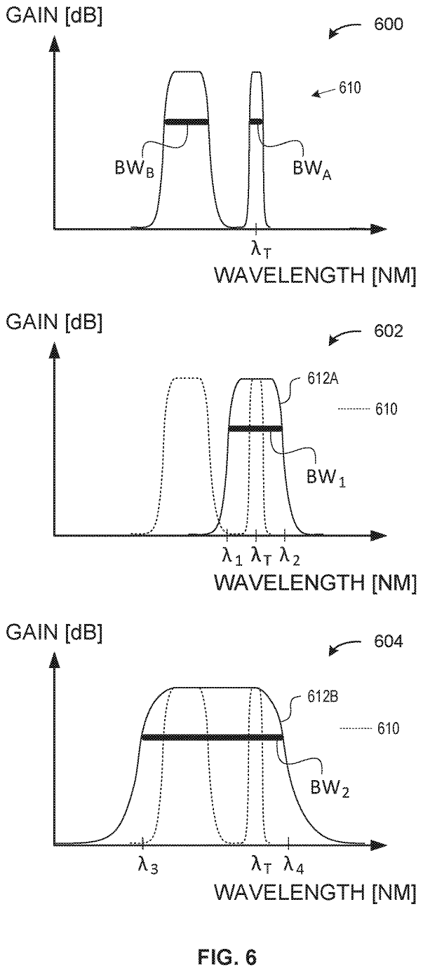

Reference is now made to FIG. 6, which depicts graph charts illustrating transfer functions of an exemplary tunable optical filter combined with a fixed narrow optical filter both positioned in a LIDAR system for transmitting light received from a FOV of the LIDAR system to one or more sensors of the LIDAR system, in accordance with embodiments of the present disclosure.

Graph chart 600 illustrates a transfer function 610 of an exemplary fixed optical filter associated with one or more sensors such as the sensor 316 of a LIDAR system such as the LIDAR system 300. The fixed optical filter may be deployed in the inbound optical path (RX) of light such as the light 356 received from an FOV such as the FOV 320 of the LIDAR system 300 such that the light received and detected by the sensor 316 is transmitted via the fixed optical filter.

As seen, the transfer function 610 of the fixed optical filter may comprise two fixed passbands, a first significantly narrow passband BW_{A} around the wavelength λ_{T} of light projected by the LIDAR system 300 such as projected light 354, and a second fixed passband BW_{B} away from the wavelength λ_{T}. For example, assuming the wavelength λT of the projected light 354 is 905 nm, the first passband BW_{A} may correspond to (comprise) wavelengths 895-915 nm, while the second passband BW_{B} may correspond to wavelengths 300-750 nm.

Graph charts 602, and 604 illustrate transfer functions one or more exemplary tunable optical filters such as the tunable optical filter 310 which is used in combination with fixed optical filter and is also positioned in the inbound optical path (RX) of the received light 356 received from the FOV 320.

Graph chart 602 illustrates an exemplary transfer function 612A of the tunable optical filter 310 when set in a first state in which the tunable optical filter 310 is configured to transmit reduced intensity light to the sensor 316. As seen, the transfer function 612A comprises a BPF BW₁ corresponding to the first passband BW_{A} of the fixed optical filter. As such, when the tunable optical filter 310 is in the first state, only light in the wavelength region of the first passband BW_{A}, for example, 895-915 nm, may be transmitted from the FOV 320 to the sensor 316.

Graph chart 604 illustrates an exemplary transfer function 612B of the tunable optical filter 310 when set in a second state in which the tunable optical filter 310 is configured to transmit increased intensity light to the sensor 316. As seen, the transfer function 612B comprises a BPF BW₂ corresponding to both the first passband BW_{A} and the second passband BW_{B} of the fixed optical filter. As such, when the tunable optical filter 310 is in the second state, light in the wavelength regions of the first passband BW_{A}, and the second passband BW_{B} for example, 895-915 nm and 300-750 nm may be transmitted from the FOV 320 to the sensor 316.

As such, in both the first and second states, the tunable optical filter 310 may transmit, to the sensor 316, light 354 projected by the LIDAR system 300 and reflected from object(s) in the FOV 320, i.e., light corresponding to the first passband BW_{A}, while in the second state, in addition to the light corresponding to the first passband BW_{A}, the tunable optical filter 310 may further transmit to the sensor 316 additional light corresponding to the second passband BW_{B} of the fixed optical filter.

Optionally, in the second state of the tunable optical filter 310, rather than configuring the tunable optical filter 310 to have the transfer function 610B, the tunable optical filter 310 may be simply removed from the inbound optical path (RX) of the received light 356. For example, the tunable optical filter 310 may comprise one or more mechanically movable optical filters, described in detail hereinafter, which may be moved between two or more states. For example, in a first the mechanically movable optical filters may be positioned in the inbound optical path (RX) of the received light 356, and in a second state the mechanically movable optical filters may be positioned out of the inbound optical path (RX) of the received light 356, i.e., removed from the inbound optical path (RX).

As such, in the first state of the tunable optical filter 310, the light received by the sensor 316 may be defined by the combination of the transfer functions of the tunable optical filter 310 and the fixed optical filter, for example, transfer functions 610 and 612A meaning that only light having wavelengths corresponding to the first passband BW_{A} may be transmitted to the sensor 316. However, in the second state of the tunable optical filter 310, specifically in the absence of the tunable optical filter 310 in the inbound optical path (RX), only the fixed optical filter defines the wavelength and hence the level of light transmitted to the sensor 316. As such, in the second state of the tunable optical filter 310, the light transmitted to the sensors 316 may include light in the wavelength corresponding to both the first passband BW_{A} and the second passband BW_{B}.

The tunable optical filter 310, which as described hereinbefore, are positioned within the inbound optical path through which reflected light 356 (RX) is directed from the FOV 320 to the sensor 316, may be implemented as independent elements and/or integrated with one or more other elements, units, and/or components of the LIDAR system 300. For example, one or more tunable optical filters 310 may be integrated with the sensor 316. In such case, the integrated tunable optical filter 310 may be positioned inside the sensor 316 over a sensing surface of the light detection elements of the sensor 316 such that light 356 directed toward the sensor 316 is transmitted (transferred) via the integrated tunable optical filter 310 to the sensing surface. In another example, one or more tunable optical filters 310 may be independent of other components of the LIDAR system 300, specifically independent of the sensor 316. In such case, the tunable optical filter 310 may be positioned in one or more locations along the inbound optical path of the reflected light 356 received from the FOV 320 such that such that the reflected light 356 is transmitted (transferred) via the integrated tunable optical filter 310 to the sensor 316.

The tunable optical filter 310 may utilize one or more optical (light) filtering techniques as known in the art. For example one or more tunable optical filters 310 may apply absorptive filtering in which light in one or more wavelengths and/or wavelength regions are absorbed by the optical filter while other wavelengths are transmitted through. In another example, one or more tunable optical filters 310 may employ reflective filtering using one or more mirror like materials and/or coatings configured to selectively reflect light in some wavelengths while transmitting other light wavelengths. In another example, or more tunable optical filters 310 may apply interference filtering (dichroic filtering, thin-film filter) using material layers having selected refractive indexes for selectively transmitting (transferring) or even amplifying some light wavelengths through constructive interference while attenuating or even canceling other light wavelengths through destructive interference.

To implement one or more of these filtering technologies, and specifically to support dynamic adjustment of the width of their passband, the tunable optical filters 310 may utilize one or more technologies, architectures, designs, and/or structures.

For example, one or more tunable optical filters 310 may comprise one or more electrically tunable bandpass filters which may be operated to adjust the width of their passband by adjusting one or more excitation signals, for example, a current, a voltage, an electric field, a magnetic field, a sound wave, and/or the like. Such electrically tunable bandpass filters may be utilized using one or more active elements, for example, a Liquid Crystal Tunable Filter (LCTF), a ring resonator, an Acousto-Optical Tunable Filter (AOTF), and/or the like. Through application of different values of the excitation signal, the tunable optical filter may be excited, configured, and/or operated to adjust the width of their passband. The width of the passband of these electrically tunable bandpass filters may be adjusted within a predefined range of widths and/or selected from a plurality of width values, specifically at least two width values corresponding to the narrow BPF and the wide BPF.

For example, a LCTF may be dynamically controlled to transmit light in some wavelengths or wavelengths regions while filtering out light in one or more other wavelengths or wavelengths regions by applying an electric filed to change optical properties of the Liquid Crystal (LC) molecules thus altering polarization of light transmitted through the LC. The polarized light may be then transmitted via one or more waveplates which may filter out light polarized in one mode while transmitting light polarized in another mode. In another example, an AOTF, which is a solid-state optical filter, may be operated to transmit specific wavelengths of light by controlling a piezoelectric transducer comprising an acousto-optic crystal to adjust optical properties of the crystal for controlling diffraction of light in the crystal, specifically wavelength dependent diffraction. As known in the art, the optical properties of the crystal may be adjusted by adjusting ana acoustic frequency of waves through the crystal where the frequency o the sound waves may be controlled by applying an electrical signal (e.g., voltage, electric field, etc.) to the piezoelectric transducer.

In another example, one or more tunable optical filters 310 may include one or more mechanically moveable optical filters. For example, one or more tunable optical filters 310 may include a BPF, optionally having a fixed passband. The mechanically moveable optical filter(s) may have at least two states such that the mechanically moveable optical filters may be operated to dynamically transition between the states. In the first state, the moveable optical filter may be positioned in the reception (RX) optical path of the LIDAR system 300, i.e., the inbound optical path directing the light received from the FOV 320 toward the sensor 316 such that the light received by the sensor 316 from the FOV 320 is transferred (transmitted) via the moveable optical filter. In the second state, the moveable optical filter may be removed from the inbound optical path (RX) such that the light received by the sensor 316 from the FOV does not pass through the moveable optical filter.

The mechanically moveable optical filter may utilize one or more mechanical mechanisms for dynamically transitioning of the mechanically moveable optical filter between its states, for example, rotation, sliding, flipping, and/or the like.

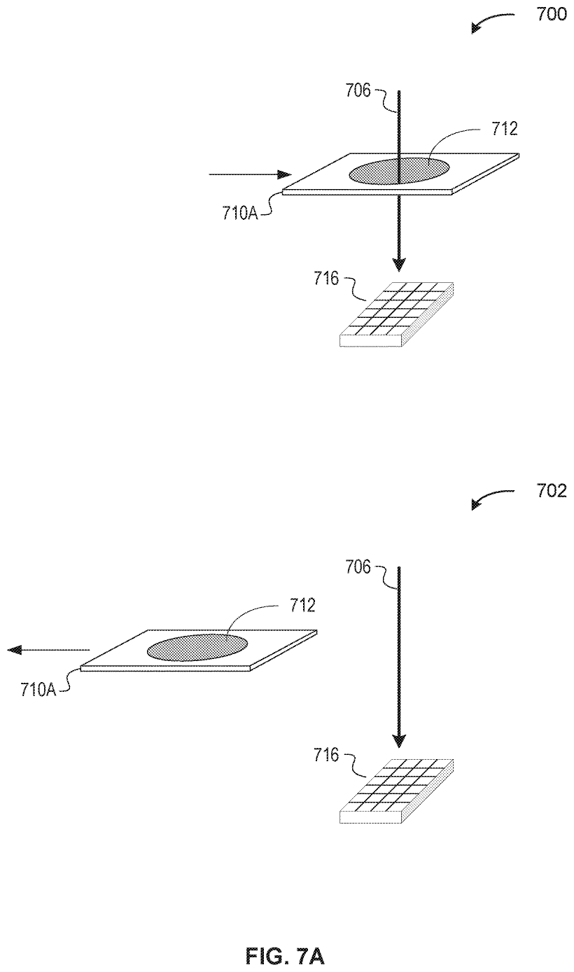

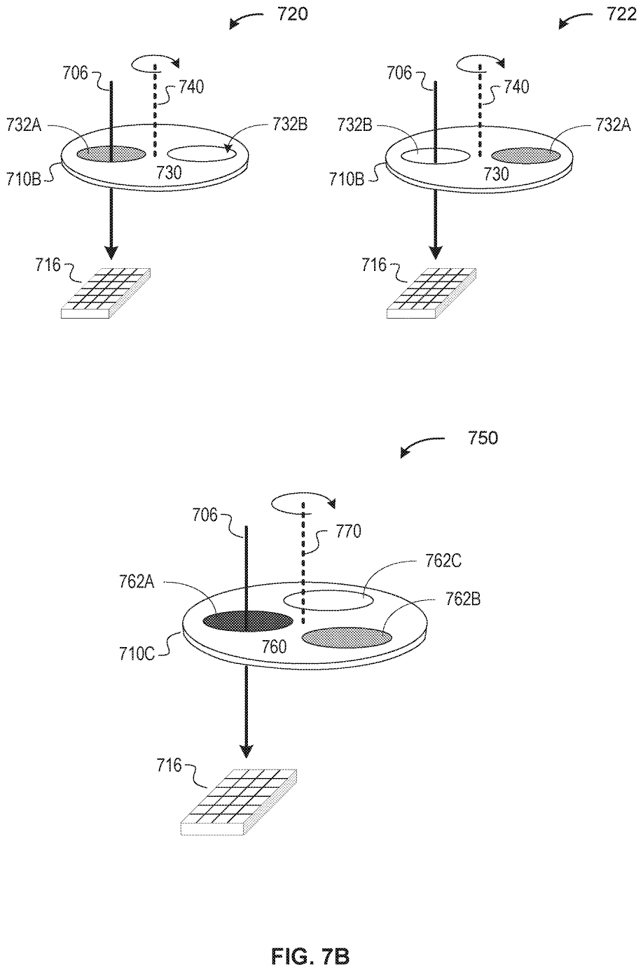

Reference is now made to FIG. 7A and FIG. 7B, which are schematic illustration of some exemplary mechanical optical filters of a LIDAR system which are moveable between states to adjust their passband width for transmitting light received from a FOV of the LIDAR system to one or more sensors of the LIDAR system, in accordance with embodiments of the present disclosure.

As shown in illustrations 700 and 702, a first exemplary tunable optical filter such as the tunable optical filter 310 may comprise a mechanical moveable optical (light) filter 710A which may be moved in and out of the inbound optical path (i.e., reception optical path RX) of a LIDAR system such as the LIDAR system 300 through which received light 706 such as the received light 356 is directed from an FOV such as the FOV 320 to the one or more sensors 716 such as the sensor 316. For brevity, sensor 716 is designated herein after in singular form but may include one or more sensors 716.

Using one or more mechanical mechanisms, for example, a push/pull mechanism, a side-to-side swinging mechanism, an up/down lifting mechanism, and/or the like, the moveable optical filter 710A may be moved, for example, slid, pushed, pulled, swung, and/or the like to transition between two states, a first state and a second state. When the moveable optical filter 710A is moved and set in the first state (illustration 700), a filtering region 712 of the moveable optical filter 710A is positioned in the inbound optical path of the LIDAR system 300 such that the light 706 received from the FOV 320 is transmitted to the sensor 716 via the filtering region 712. However, when the moveable optical filter 710A is moved and set in the second state (illustration 702), the moveable optical filter 710A is positioned out of the inbound optical path of the LIDAR system 300 such that there is no filtering of the received light 706 received from the FOV 320 and all received light 706 is transmitted to the sensor 716.

A second exemplary moveable optical filter 710B, shown in illustrations 720 and 722, may comprise a rotating disk 730 having two filtering regions, a first filtering region 732A and a second filtering region 732B. The moveable optical filter 710B may be deployed in the inbound optical path (i.e., reception optical path RX) of the LIDAR system 300 through which the received light 706 is directed from the FOV 320 to the sensor 716.

The rotating disk 730 may be rotated around an axis 740 perpendicular to the horizontal plane of the rotating disk 730. In particular, the rotating disk 730 may be rotated between two states, a first state and a second state. When the rotating disk 730 is rotated to the first state (illustration 720), the first filtering region 732A may be positioned in the inbound optical path of the LIDAR system 300 such that the light 706 received from the FOV 320 is transmitted to the sensor 716 via the first filtering region 732A. When the rotating disk 730 is rotated to the second state (illustration 722), the second filtering region 732B may be positioned in the inbound optical path of the LIDAR system 300 such that the light 706 received from the FOV 320 is transmitted to the sensor 716 via the second filtering region 732B.

Each of the first filtering region 732A and the second filtering region 732B may comprise an optical filter, specifically a fixed optical filter having a fixed width passband. The filtering regions 732, for example 732A and 732B may have filtering parameters different from each other such that each filtering region 732 may transmit (transfer) different intensity of light (amount, level, photon count, etc.). For example, the first filtering region 732A may comprise an optical filter having a transfer function corresponding to transfer function 410 illustrated in graph chart 400 in FIG. 4A, i.e., a narrow passband, while the second filtering region 732B may comprise an optical filter having a transfer function corresponding to transfer function 412 illustrated in graph chart 402, i.e., a wide passband. Optionally, one of the filtering regions, for example, the second filtering region 732B may be simply an aperture which may not apply any filtering to the received light 706 transmitted to the sensor 716 such that all wavelengths of the received light 706 may be transmitted via the moveable optical filter 710B and detected by the sensor 716.

Another exemplary moveable optical filter 710C, shown in illustrations 750, may utilize the same working concepts of the moveable optical filter 710B and may comprise be switched between a plurality of states rather than only two of the moveable optical filter 710B. For example, the moveable optical filter 710B may comprise a rotating disk 730 which may be rotated around an axis 770 perpendicular to the horizontal plane of the rotating disk 760. In particular, the rotating disk 730 may be rotated between three states, a first state, a second state, and a third state. For example, the rotating disk 760 of the moveable optical filter 710C may comprise a plurality of filtering regions corresponding to the plurality of states, for example, three filtering regions (as illustrated in 750) corresponding to the three states of the moveable optical filter 710B. A first filtering region 762A may correspond to a first state, a second filtering region 762B may correspond to a second state, and a third filtering region 762C may correspond to a third state.

The rotating optical filter 710C deployed in the inbound optical path (RX) of the LIDAR system 300, may be rotated around its axis 770 to transition between the three states. When the rotating disk 760 is rotated to the first state, the first filtering region 762A may be positioned in the inbound optical path of the LIDAR system 300 such that the light 706 received from the FOV 320 is transmitted to the sensor 716 via the first filtering region 762A. When the rotating disk 760 is rotated to the second state, the second filtering region 762B may be positioned in the inbound optical path of the LIDAR system 300 such that the light 706 received from the FOV 320 is transmitted to the sensor 716 via the second filtering region 762B. When the rotating disk 760 is rotated to the second state, the second filtering region 762C may be positioned in the inbound optical path of the LIDAR system 300 such that the light 706 received from the FOV 320 is transmitted to the sensor 716 via the second filtering region 762C.

As described for the moveable optical filter 710B, each of the first second and filtering regions 762A, 762B, and 762C may comprise an optical filter, specifically a fixed optical filter having a fixed width passband. For example, the first filtering region 762A may comprise an optical filter having a transfer function corresponding to transfer function 410 (illustrated in FIG. 4A), i.e., a narrow passband. In another example, the second filtering region 762B may comprise an optical filter having a transfer function corresponding to transfer function 412C (illustrated in FIG. 4C), i.e., a wide passband having a first width BW_{C}. In another example, the third filtering region 762C may comprise an optical filter having a transfer function corresponding to transfer function 412E (illustrated in FIG. 4C), i.e., a wide passband having a second width BW_{E} larger than the first width BW_{C}. As described with respect to the moveable optical filter 710B, one of the filtering regions 762, for example, the third filtering region 762C may optionally comprise an aperture, such that when the moveable optical filter 710C is in the third state, all wavelengths of the received light 706 may be transmitted via the aperture of the moveable optical filter 710B and detected by the sensor 716.

According to some embodiments described herein, one or more tunable optical filters such as the tunable optical filter 310 may be facilitated by combining one or more optical Low Pass Filters (LPF) and one or more optical High Pass Filters (HPF) as know in the art. One or more LPFs and one or more HPFs may be positioned and/or deployed in the inbound optical path (RX) of a LIDAR system such as the LIDAR system 300 such that received light such as the light 356 received from the FOV 320 is directed to the sensor 316 via the optical LPFs and HPFs. In particular, one or more LPFs and one or more HPFs may be selected, configured, and/or operated to have transfer functions which combined together may apply an optical BPF having a desired bandpass width. This means that the transfer functions of the optical HPF(s) and LPF(s) may have a common (overlapping) frequency (wavelength) region corresponding to the desired bandpass width as known in the art.

For brevity, a single optical LPF and a single optical HPF are described herein after. This, however, should not be construed as limiting since, as may be apparent to a person skilled in the art, multiple optical LPFs and/or HPFs may be deployed in the LIDAR system 300 to apply the desired BPF.

The received light 356 may be directed through a first optical filter positioned on the reception optical path, for example, an optical LPF such that lower frequency components of the received light 356 are transmitted via the optical LPF while its higher frequency components are filtered out (blocked, removed, reflected, etc.) according to the selected transfer function of the optical HPF. The received light 356, specifically the lower frequency components of the received light 356 may then pass through a second optical filter positioned on the reception optical path, specifically an optical HPF such that higher frequency components of the received light 356 are transmitted via the optical HPF while its lower frequency components are filtered out according to the selected transfer function of the optical HPF. The HPF and LP may be selected, configured, and/or operated such that the frequency (wavelength) components that pass through both the LPF and HPF are within a certain desired bandpass.

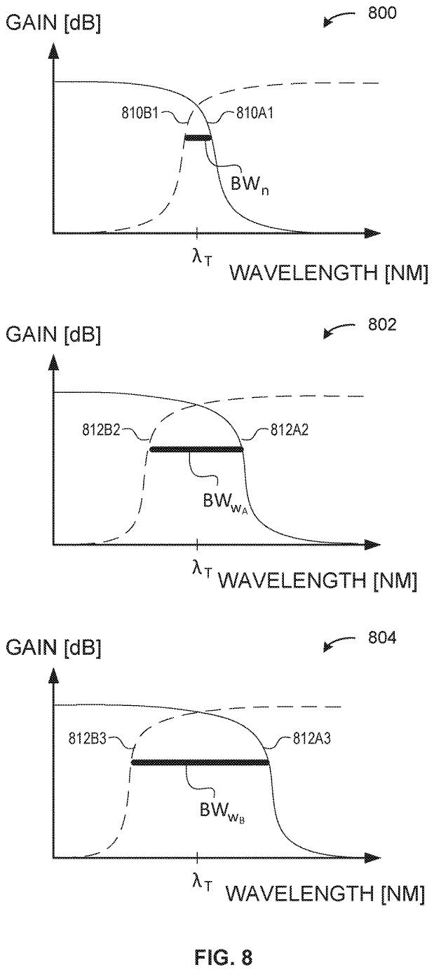

Reference is now made to FIG. 8, which depicts graph charts illustrating transfer functions of exemplary optical LPF and HPF positioned in a LIDAR system for transmitting light received from a FOV of the LIDAR system to one or more sensors of the LIDAR system, in accordance with embodiments of the present disclosure.

Graph charts 800, and 802 show transfer function graphs of exemplary optical filters, in particular, of an optical LPF and an optical HPF positioned and/or configured to transmit light received from a FOV such as the FOV 320 to one or more sensors such as the sensor 316 of a LIDAR system such as the LIDAR system 300. The optical LPF and HPF may be operated to adjust their passbands in order to jointly form bandpass filter (BPF) having a desired passband width. As stated herein before with respect to the tunable optical filter 310, one or more of the optical LPF and HPF may be operated and/or configured to adjust a width of their passband, either selected from a certain range, and/or from a plurality of discrete states each corresponding to a respective width.

For example, as illustrated in graph chart 800, in a first state, the exemplary optical LPF may be operated to adjust its passband according to transfer function 810A1. In addition, the exemplary optical HPF may be operated to adjust its passband according to transfer function 810B1. As seen, the combined transfer functions 810A1 and 810B1 may form a BPF having a significantly narrow passband with a width corresponding to BWₙ.

In another example, as illustrated in graph chart 802, in a second state, the optical LPF may be operated to adjust its passband according to transfer function 812A2 while the optical HPF may be operated to adjust its passband according to transfer function 812B2 such that the combined transfer functions 812A1 and 812B1 may form a BPF having a significantly wide passband with a width corresponding to BW_{w}_{_{A}}.

As described with respect to the illustrations in FIG. 4A, in both states, the passband of BPF formed by the combination of the optical LPF and the optical HPF may comprise wavelength λ_{T} which is the wavelength of the light projected by the LIDAR system 300 for scanning the FOV 320 so that projected light such as projected light 354 which is reflected from one or more objects in the FOV 320, i.e., reflected light 356, may pass through the jointly formed BPF and be transmitted to the sensor 316 which is essential for object detection functionality of the LIDAR system 300.

Optionally, one or more of the optical LPF and the optical HPF may be operable to dynamically adjust the width of their respective passband to a plurality of widths rather than only two widths, as described herein before, namely the narrow passband with width BWₙ and the wide passband with width BW_{w}. For example, as illustrated in graph chart 804, the LPF and/or the HPF may be operable to adjust their passband according to transfer functions 812A3 and 812B3 respectively such that the two optical filters jointly form a BPF having a significantly wide passband width BW_{w}_{_{B}} larger than BW_{w}_{_{A}}.

One or more designs, architecture, and/or mechanisms may be used for deploying optical LPF(s) and optical HPF(s) to implement a BPF for controlling the intensity of light received from the FOV 320 that is transmitted to the sensor 316. For example, each of the LPF and/or the HPF may use one or more mechanically moveable optical (light) filters, optionally filters having a fixed passband.

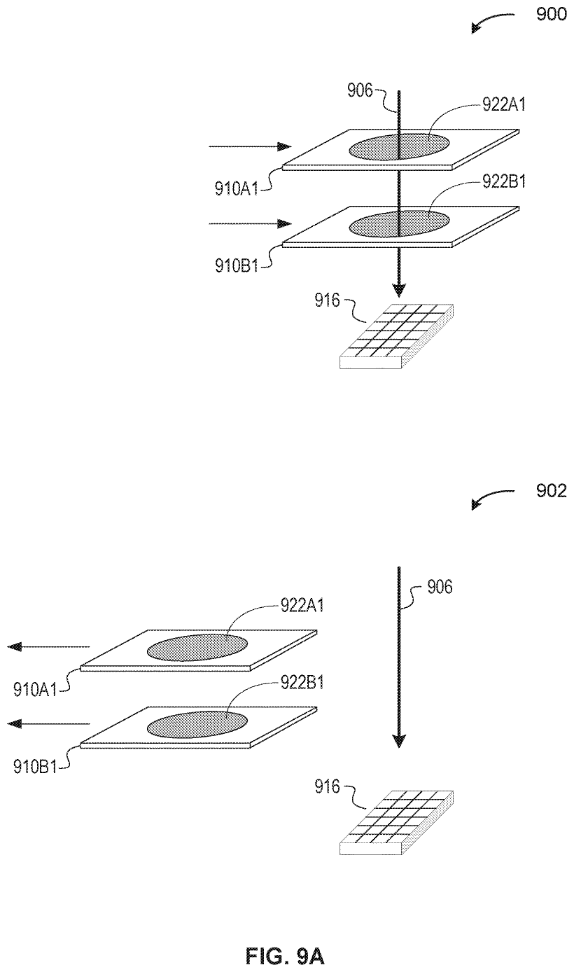

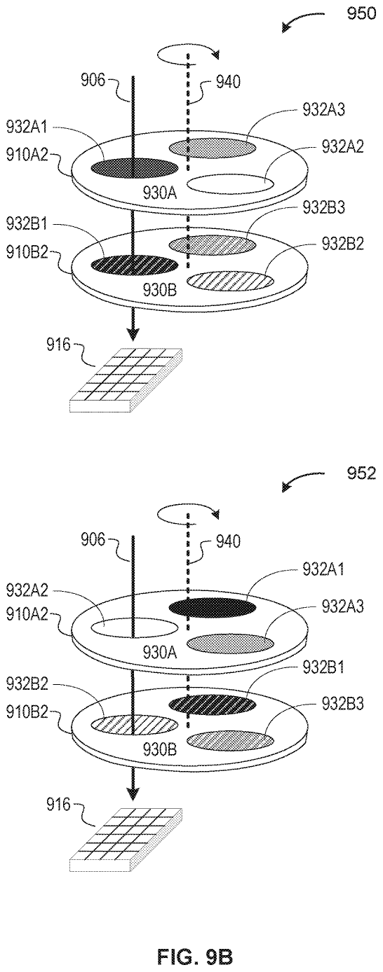

Reference is now made FIG. 9A and FIG. 9B, which are schematic illustrations of some exemplary mechanical LPF and HPF of a LIDAR system which are moveable between states to adjust their passband width for transmitting light received from a FOV of the LIDAR system to one or more sensors of the LIDAR system, in accordance with embodiments of the present disclosure.

As shown in illustrations 900 and 902, an exemplary tunable optical filter may be implemented using two mechanical moveable optical (light) filters, a first mechanical optical filter 910A1 and a second mechanical optical filter 910B1 which may be moved in and out of the inbound optical path (i.e., reception optical path RX) of a LIDAR system such as the LIDAR system 300 through which received light 906 such as the received light 356 is directed from an FOV such as the FOV 320 to the one or more sensors 916 such as the sensor 316. For brevity, sensor 916 is designated herein after in singular form but may include one or more sensors 916.

The first mechanically moveable filter 910A1 may be an optical LPF comprising a first filtering region 922A1 having a transfer function corresponding, for example, to the LPF transfer function 810A1. The second mechanically moveable filter 910B1 may be an optical HPF comprising a second filtering region 922B1 having a transfer function corresponding, for example, to the LPF transfer function 810B1.

As described with respect to illustrations 700 and 702, one or more mechanical mechanisms, for example, a push/pull mechanism, a side-to-side swinging mechanism, an up/down lifting mechanism, and/or the like, may be used to move the moveable optical filters 910A and 910B1, for example, slide, push, pull, swing, and/or the like to transition (switch) the optical filters 910A and 910B1 between two states, a first state and a second state.

When the first and second optical filters 910A1 and 910B1 are moved and set in the first state (illustration 900), the filtering regions 922A1 and 922B1 are positioned in the inbound optical path of the LIDAR system 300 such that the light 906 received from the FOV 320 is transmitted to the sensor 916 via the filtering regions 922A1 and 922B1. However, when the first and second optical filters 910A1 and 910B1 are moved and set in the second state (illustration 902), the first and second optical filters 910A1 and 910B1 are positioned out of the inbound optical path of the LIDAR system 300 such that there is no filtering of the received light 906 received from the FOV 320 and all received light 906 is transmitted to the sensor 916.

Another exemplary moveable optical filter, shown in illustrations 950 and 952, may comprise two rotating optical filters, an optical LPF 910A2 and an optical HPF 910B2. Each of the optical LPF 910A2 and an optical HPF 910B2 may comprise a rotating disk 930 having one or more filtering regions 932 and rotatable around an axis 940 perpendicular to the horizontal plane of the rotating disk 930. For example, the optical LPF 910A2 may comprise a rotating disk 930A which includes three filtering regions 932A1, 932A2, and 932A3. In another example, the optical HPF 910B2 may comprise a rotating disk 930B which includes three filtering regions 932B1, 932B2, and 932B3.

The moveable optical filters 910A2 and 910B2 may be deployed in the inbound optical path (i.e., reception optical path RX) of the LIDAR system 300 through which the received light 906 is directed from the FOV 320 to the sensor 916. The rotating disks 930A and 930B may be rotated around an axis 740 perpendicular to the horizontal plane of the rotating disks 930A and 930B.

In particular, the rotating disks 930A and 930B may be rotated between a plurality of states, for example, two states, three states, four states, and/or the like. For example, as shown in illustrations 950 and 952, the rotating disks 930A and 930B may be rotated between three states such that in each state a respective filtering region 932 may be positioned in the inbound optical path of the LIDAR system 300 such that the light 906 received from the FOV 320 is transmitted to the sensor 916 via the respective filtering region 932A.

For example, when the rotating disk 930A is rotated to the first state (illustration 950), the first filtering region 932A1 may be positioned in the inbound optical path such that the light 906 received from the FOV 320 is transmitted to the sensor 916 via the first filtering region 932A1. When the rotating disk 930A is rotated to the second state (illustration 952), the second filtering region 932A2 may be positioned in the inbound optical path such that the light 906 received from the FOV 320 is transmitted to the sensor 916 via the first filtering region 932A2. When the rotating disk 930A is rotated to the second state (not shown), the third filtering region 932A3 may be positioned in the inbound optical path such that the light 906 received from the FOV 320 is transmitted to the sensor 916 via the first filtering region 932A3.

Similarly, when the rotating disk 930B is rotated to the first state (illustration 950), the first filtering region 932B1 may be positioned in the inbound optical path such that the light 906 received from the FOV 320 is transmitted to the sensor 916 via the first filtering region 932B1. When the rotating disk 930B is rotated to the second state (illustration 952), the second filtering region 932B2 may be positioned in the inbound optical path such that the light 906 received from the FOV 320 is transmitted to the sensor 916 via the first filtering region 932B2. When the rotating disk 930B is rotated to the second state (not shown), the third filtering region 932B3 may be positioned in the inbound optical path such that the light 906 received from the FOV 320 is transmitted to the sensor 916 via the first filtering region 932B3.

The rotating disks 930A and 930B may be rotated together, i.e., synchronized with each other such that each of filtering regions of the optical LPF 910A2 is always coupled with the same filtering region of the optical HPF 910B2. However, optionally the rotating disks 930A and 930B may be rotated separately such that each filtering region of the optical LPF 910A2 may be coupled with a selected one of the filtering regions of the optical HPF 910B2.

Each of the filtering regions 932A1, 932A2, and 932A3 of the optical LPF 910A2 may comprise an optical filter, specifically a fixed optical LPF having a fixed width passband. For example, the first filtering region 932A1 may comprise an optical LPF having a transfer function corresponding to transfer function 810A1 illustrated in graph chart 900 in FIG. 9, the second filtering region 932A2 may comprise an optical LPF having a transfer function corresponding to transfer function 810A2, and the third filtering region 932A3 may comprise an optical LPF having a transfer function corresponding to transfer function 810A3.

Similarly, each of the filtering regions 932B1, 932B2, and 932B3 of the optical HPF 910B2 may comprise an optical filter, specifically a fixed optical HPF having a fixed width passband. For example, the first filtering region 932B1 may comprise an optical HPF having a transfer function corresponding to transfer function 810B1 illustrated in graph chart 900 in FIG. 9, the second filtering region 932B2 may comprise an optical HPF having a transfer function corresponding to transfer function 810B2, and the third filtering region 932B3 may comprise an optical HPF having a transfer function corresponding to transfer function 810B3.

As such, when rotating the rotating disks 930A and 930B to a first state, for example, as illustrated in 950, the combination of the first region 932A1 of the optical LPF 910A2 and the first region 932B1 of the optical HPF 910B2 may jointly form a BPF having a transfer function corresponding to the transfer function illustrated in graph chart 800 having a bandpass width BWₙ. In another example, when rotating the rotating disks 930A and 930B to a second state, for example, as illustrated in 952, the combination of the second region 932A2 of the optical LPF 910A2 and the second region 932B2 of the optical HPF 910B2 may jointly form a BPF having a transfer function corresponding to the transfer function illustrated in graph chart 802 having a bandpass width BW_{w}_{_{A}}. In another example, when rotating the rotating disks 930A and 930B to a third state (not shown), the combination of the third region 932A3 of the optical LPF 910A2 and the third region 932B3 of the optical HPF 910B2 may jointly form a BPF having a transfer function corresponding to the transfer function illustrated in graph chart 804 having a bandpass width BW_{w}_{_{B}}.

Optionally, the LPF and an HPF may be used in combination with a fixed multiband optical filter as described herein above with respect to the tunable optical filter 310, for example, with respect to FIG. 6. In such case, the LPF and the HPF may be dynamically operated to adjust the combined passband, specifically increase and reduce the combined passband to correspond to the fixed passbands of the fixed optical filter. For example, in a first state, in order to reduce the light intensity transmitted to the sensor 316, the LPF and the HPF may be operated to adjust, specifically reduce, the width of their combined passband as expressed by exemplary transfer functions 810, formed by the combination of transfer functions 810A1 and 810B1, to correspond to the first fixed passband of the fixed multiband optical filter BW_{A} of transfer function 610 as illustrated in graph chart 602. In a second state, in order to increase the light intensity transmitted to the sensor 316, the LPF and the HPF may be operated to adjust, specifically increase, the width of their combined passband as expressed by exemplary transfer functions 812, formed by the combination of transfer functions 812A2 and 810B2, or 812A3 and 812B3, to correspond to both the first fixed passband BW_{A} and the second fixed passband BW_{B} of the fixed multiband optical filter of transfer function 610 as illustrated in graph chart 604.

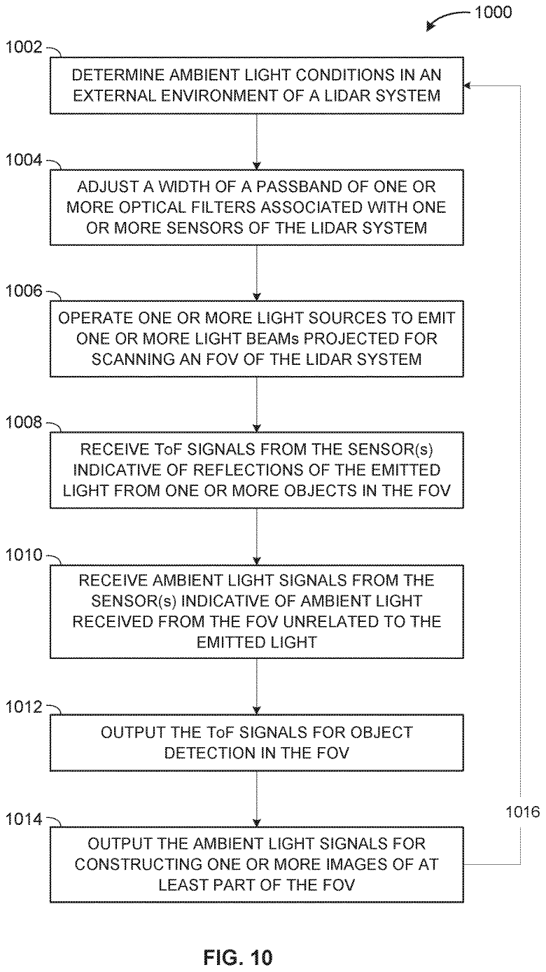

Reference is now made to FIG. 10, which is a flow chart of an exemplary process of adjusting passband width of one or more tunable optical filters positioned in a LIDAR system for transmitting light received from a FOV of the LIDAR system to one or more sensors of the LIDAR system, in accordance with embodiments of the present disclosure.

An exemplary process 1000 may be executed, for example, by one or more processors such as the processor 318 of one or more LIDAR systems such as the LIDAR system 300 for dynamically adjusting the width of the passband of one or more tunable optical filters such as the optical filter 310 positioned in the LIDAR system 300 for controlling light such as the light 356 received from a FOV such as the FOV 320 of the LIDAR system 300 and directed to one or more sensors such as the sensor 316 of the LIDAR system 300.

In particular, the width of the passband of the tunable optical filter 310 may be adjusted according to one or more ambient light conditions detected in the external environment of the LIDAR system 300 in order to control the intensity of the received light 356, specifically received ambient light received from the FOV 320 that is transmitted (transferred) to the sensor 316.

The process 1000 may be an iterative process executed to determine current (new) ambient light conditions and control the tunable optical filter 310 accordingly to increase or reduce the intensity of the received ambient light 356 that is transmitted to the sensor 316.

As described herein before, the sensor 316 may generate signal data indicative of light detected by the sensor 316, specifically indicative of the light 356 received from the FOV 320 and transmitted (transferred) to the sensor 316 via the tunable optical filter 310.

The received light 356 may include light reflected from one or more objects in the FOV 320 which are illuminated with light such as the projected light 354 projected by the LIDAR system. Signal data generated by the sensor 316 which is indicative of the projected light 354 that is reflected from the FOV 320 may be used for computing Time of Flight (ToF) of the projected light 354 to objects in the FOV 320 and back to the LIDAR 300. This signal data, designated ToF signal data hereinafter, may be used for detecting objects in the FOV 320 as known in the art and one or more attributes of the detected objects, for example, a distance of the objects (from the LIDAR system 300), and position of objects (in one or more coordinate systems). Optionally, the detected object attributes may further include additional attributes, for example, reflectivity, motion (e.g., velocity, acceleration, etc. whether in absolute, and/or relative terms), and/or the like.

However, the received light 356 may also include ambient light that is unrelated to the light 354 projected by the LIDAR system 300, i.e., light originating from one or more external sources, for example, sunlight, an external light source, and/or the like. Signal data generated by the sensor 316 which is indicative of ambient light unrelated to the projected light 354 is designated ambient light signal data hereinafter and may be used for constructing one or more images of the FOV 320 and/or part thereof.

As shown at 1002, the process 1000 may start with determining one or more ambient light conditions in the external environment of the LIDAR system 300, for example, by the processor 318. The ambient light conditions may include one or more parameters of the ambient light detected in the environment of the LIDAR system 300, for example, an intensity of the ambient light, a wavelength of the ambient light, and/or the like.

The processor 318 may determine the ambient light conditions based on sensory data received from one or more sensors. For example, the processor 318 may determine one or more of the ambient light conditions, for example, intensity of the ambient light based on signal data generated by one or more of the sensor 316, in particular, signal data generated during one or more no-projection time periods during which the projected light 354 reflected from objects in the FOV 320 is not expected and/or estimated to be received and detected by the sensor 316. Such no-projection time periods may include, for example, a time period immediately before projecting light 354, a certain period following projection of light 354 after which light reflected in response to projected light 354 is not expected to arrive at the LIDAR system 300, e.g., beyond range of the LIDAR system 300, and/or the like.

In another example, the processor 318 may determine one or more of the ambient light conditions based on sensory data received from one or more other sensors different and separate from the sensor 316 which may be either sensors of the LIDAR system 300 and/or sensors deployed externally to the LIDAR system 300. For example, the processor 318 may determine one or more of the ambient light conditions, for example, intensity of the ambient light based on signal data generated by one or more light sensor (e.g., photodetector, etc.) different from the sensor 316 which are configured to detect light in one or more wavelength regions and generate signal data accordingly. In another example, the processor 318 may determine wavelengths and/or wavelength regions (spectral region) of the ambient light based on signal data generated by one or more sensors (e.g., spectrometer, etc.) configured to detect wavelength of light and generate signal data accordingly.

Optionally, the processor 318 may receive one or more ambient light conditions from one or more other processor(s), for example, a processor such as the processor 218 of a host system which may obtain, and/or determine the ambient light conditions based on one or more data sets, for example, sensory data, location data, environmental data, and/or the like.

As shown at 1004, the processor 318 may adjust the width of the passband of one or more of the tunable optical filter 310 according to one or more of the ambient light conditions determined in the external environment of the LIDAR system 300.

Specifically, the processor 318 may adjust the width of the passband of the tunable optical filter 310 in order to control the intensity of ambient light (e.g., light level, amount of light, photon count, etc.) transmitted via the tunable optical filter 310 to the sensor 316. The intensity of the ambient light transmitted via the tunable optical filter 310 to the sensor 316 may be controlled to allow sufficient ambient light to be detected by the sensor 316 such that the ambient signal data generated by the sensor 316, which is indicative of the detected ambient light, may be used for constructing images of the FOV 320 and/or part thereof, specifically images having increased quality, for example, improved accuracy, improved clarity, sufficient brightness, high contrast, high resolution, and/or the like.

The processor 318 may determine that sufficient ambient light is detected by the sensor 316 based on comparison with one or more predefined thresholds. For example, the processor 318 may compare between the intensity (level) of light detected by the sensor 316, during one or more of the no-projection time periods, and a predefined threshold defining a minimal level of ambient light detected by the sensor 316 which may enable generation of ambient signal data by the sensor 316 that may be used for constructing images of the FOV 320 and/or part thereof with acceptable and/or desired quality which may be expressed in one or quality parameters (e.g., clarity, brightness, contrast, accuracy, resolution, etc.). In another example, the processor 318 may compare between the intensity (level) of ambient light measured in the external environment of the LIDAR system 300 and a predefined threshold defining a minimal ambient light level which may induce generation of ambient signal data by the sensor 316 that may be used for constructing images of the FOV 320 and/or part thereof with acceptable and/or desired quality.

For example, assuming the processor 318 identifies low ambient light conditions, for example, low intensity ambient light in the external environment of the LIDAR system 300, for example, at night, in a tunnel, in a closed parking lot, and/or the like. In such case, the processor 318 may operate the tunable optical filter 310 to increase the width of the passband of the tunable optical filter 310 in order to increase the intensity of received light 356 transmitted via the tunable optical filter 310 to the sensor 316 thus increasing the level of light detected by the sensor 316.

In another example, assuming the processor 318 identifies high ambient light conditions, i.e., high intensity ambient light in the external environment of the LIDAR system 300, for example, during bright sun days, in IR intense environment, in the presence of one or more high intensity external light sources, and/or the like. In such case, the processor 318 may operate the tunable optical filter 310 to reduce (decrease) the width of the passband of the tunable optical filter 310 in order to reduce the intensity of received light 356 transmitted via the tunable optical filter 310 to the sensor 316 thus reducing the level of light detected by the sensor 316.

Moreover, while the processor 318 may adjust the width of the passband of the tunable optical filter 310 to ensure that sufficient ambient light is detected by the sensor 316, the processor 318 may further adjust the passband width of the tunable optical filter 310 to reduce ambient light noise, i.e., reduce the level of optical noise induced by the ambient light received from the FOV 320 and detected by the sensor 316.

For example, assuming the processor 318 identifies high ambient light conditions, for example, high intensity ambient light in the external environment of the LIDAR system 300, the processor 318 may operate the tunable optical filter 310 to reduce the width of the passband of the tunable optical filter 310 in order to reduce the optical noise induced by the ambient light received from the FOV 320 and transmitted via the tunable optical filter 310 to the sensor 316 thus reducing the level of optical noise detected by the sensor 316.

In another example, assuming the processor 318 identifies low Signal to Noise Ratio (SNR) in the light signal detected by the sensor 316 in response to projection of light 354, for example, due to excessive ambient light, the processor 318 may operate the tunable optical filter to reduce the width of the passband of the tunable optical filter 310 in order to reduce the optical noise in the light detected by the sensor 316.

The processor 318 may determine an acceptable level of ambient light noise, which may induce an acceptable degradation to the ambient light images, based on comparison with one or more predefined thresholds. For example, the processor 318 may compare between the intensity of the ambient light (detected and measured during one or more no-projection time periods) and a predefined threshold defining a maximal level of ambient light detected by the sensor 316 which may enable generation of ambient signal data by the sensor 316 which when used for constructing images of the FOV 320 and/or part thereof may produce acceptable and/or desired quality of the images. In another example, the processor 318 may compare between the SNR of light reflected from one or more objects in the FOV 320 which are illuminated with the projected light 354 and a predefined threshold defining a minimal SNR.

Optionally, the processor 318 may adjust the width of the passband of the tunable optical filter 310 according to a tradeoff between sufficient ambient light detected by the sensor 316 and reduced ambient light noise (optical noise) induced by the ambient light. For example, the processor 318 may execute one or more multi-objective optimization process using the ambient light conditions in order to find a solution from a solution space that satisfies two objectives which may be partially inter-dependent, specifically a minimal level of ambient light and a maximal level of optical noise induced by the ambient light. Based on the multi-object optimization, an optimal width of the passband of the tunable optical filter 310 may be determined for transmitting optimal intensity ambient light to the sensor 316 such that the images constructed based on the ambient signal data generated by the sensor 316 and indicative of the ambient light transmitted via the tunable optical filter 310 may have optimal quality under the determined ambient light conditions.

The processor 318 may adjust the width of the passband of the tunable optical filter 310 by operating the tunable optical filter 310 according to the technology, structure, and/or implementation of the tunable optical filter 310. For example, in case the tunable optical filter 310 is utilized by one or more mechanical optical filters such as, for example, the moveable optical filter 610A, the rotatable optical filter 710B, the rotatable optical filter 710C, the moveable optical filter 910A1, the moveable optical filter 910B1, the rotatable optical filter 910A2, the rotatable optical filter 910B2, and/or the like, the processor 318 may operate one or more mechanical elements, for example, an actuator, a motor, and/or the like configured to move the respective mechanical optical filter to adjust the passband width of the one or more mechanical optical filter according to one or more of the determined ambient light conditions.

In another example, assuming the tunable optical filter 310 is utilized by one or more electrically tunable optical filters, for example, an AOTF, a LCTF, a ring resonator, and/or the like, the processor 318 may control one or more electric circuit, components, and/or devices configured to generate electrical signals for exciting, operating, and/or configuring the tunable optical filters to the passband width of the electrically tunable optical filters according to one or more of the determined ambient light conditions.

As shown at 1006, the processor 318 may operate the LIDAR system 300 to scan the FOV 320 and/or part thereof by operating one or more light sources such as the light source 312 to emit one or more light beams projected (projected light 354) for illuminating the FOV 320 and/or part thereof.

As shown at 1008, the processor 318 may receive signal data generated by the sensor 316, in particular, ToF signal data indicative of light 356 reflected from one or more objects in the FOV 320 illuminated with the projected light 354.

As shown at 1010, the processor 318 may receive signal data generated by the sensor 316, in particular, ambient light signal data indicative of light 356 received from the FOV 320 which is unrelated to the projected light 354.

In order to ensure that the ambient light signal data is not affected by the light 354 projected by the LIDAR system 300 and thus is accurately representative of the ambient light in the external environment of the LIDAR system, the signal data generated by the sensor 316 may be collected during one or more time periods, designated no-projection time periods, during which the projected light 354 is not expected and/or estimated not to be received and detected by the sensor 316. The no-projection time periods may include, for example, one or more time periods preceding projection of light 354. In another example, the no-projection time periods may include one or more time periods following projection of light 354 after which light 356 reflected in response to projected light 354 is not expected to arrive at the LIDAR system 300, e.g., beyond a maximal detection range of the LIDAR system 300, and thus not expected and/or estimated to be detected by the sensor 316.

As shown at 1012, the processor 318 may output the ToF signal data generated by the sensor 316 which is indicative of the light 354 projected by the LIDAR system and reflected from one or more objects in the FOV 320 and/or part thereof. As described herein before, one or more objects and their attributes may be determined based on the ToF signal data, in particular in combination information relating to the projected light 354, for example, timing, intensity, modulation, and/or the like. Moreover, one or more 3D models of the environment of the LIDAR system 300 may be constructed and/or created based on the ToF signal data, for example, a point cloud model, a polygon mesh, a depth image holding depth information for each pixel of a 2D image and/or array, and/or any other type of 3D model of the scene.

As shown at 1014, the processor 318 may output the ambient light signal data generated by the sensor 316 which is indicative of ambient light received from the FOV 320 and/or part thereof which is unrelated to the projected light 354. As also described herein before, one or more images of the FOV 320 and/or part thereof may be constructed, created, and/or generated based on the ambient light signal data.

As described herein before, the process 1000 may be an iterative process executed continuously, periodically and/or on demand to detect changes in the ambient light conditions in the external environment of the LIDAR system 300 and control the tunable optical filter 310 accordingly to increase or reduce the intensity of the received ambient light that is transmitted to the sensor 316. As shown at 1016, in each iteration, the processor 318 may branch back to step 1002 of the process 1000 to determine current ambient light conditions in the environment of the LIDAR system 300. In case it detects a change in one or more of the ambient light conditions, the processor 318 may execute the process 1000 again to adjust the width of one or more of the passband of the tunable optical filter 310 according to the one or more newly determined ambient light conditions.

Optionally, according to some embodiments, the processor 318 may be further configured to adjust the width of the passband of the tunable optical filter 310 in real-time. Real-time in the context of these embodiments means high speed adjustment of the passband width between detection of reflections of the projected light 354 from the FOV 320 by the sensor 316 and detection of ambient light unrelated to the projected light 354 by the sensor 316. In particular, the tunable optical filter 310 may be operated to dynamically switch in real-time between a narrow passband (e.g., BWₙ of transfer function 410 illustrated in FIG. 4A) when the sensor 316 are configured and/or operated to detect the reflections of the projected light 354 from objects in the FOV 320 and a wide passband (e.g., BW_{w} of transfer function 412 illustrated in FIG. 4A) when the sensor 316 are configured and/or operated to detect ambient light.

In particular, during one or more first time periods of one or more scan cycles of the FOV 320 by the LIDAR system 300, for example, during one or more no-projection time periods during which the light 354 projected by the LIDAR system and reflected from the FOV 320 is estimated not to arrive the sensor 316, the processor 318 may adjust the width of the passband of the tunable optical filter 310 to set an increased width passband, for example, as expressed by the bandpass BW_{w} of transfer function 412 (FIG. 4A). Tuning the passband of the tunable optical filter 310 to the increased passband may be typically done when detecting low ambient light conditions, thus significantly increasing intensity of the ambient light transmitted via the tunable optical filter 310 and detected by the sensor 316. Increasing the ambient light intensity during time periods of detecting ambient light unrelated to the projected light 354 may significantly increase the level of ambient light detected by the sensor 316 which may significantly improve quality of images constructed based on the ambient light signal data generated by the sensor 316 indicative of the increased intensity ambient light.

However, during one or more second time periods of one or more scan cycles of the FOV 320 by the LIDAR system 300, during which the light 354 projected by the LIDAR system 300 and reflected from the FOV 320 is estimated to arrive the LIDAR system 300 and be detected by the sensor 316, the processor 318 may adjust the width of the passband of the tunable optical filter 310 to set a reduced passband width, for example, as expressed by the bandpass BWₙ of transfer function 410 (FIG. 4A). Tuning the passband of the tunable optical filter 310 to the reduced passband may significantly reduce ambient light which may be received and detected by the sensor 316 in addition to reflections 356 of the projected light 354. Reducing the light intensity during time periods of detecting the reflected light 356 may significantly reduce ambient light noise and thus increase SNR of the reflected light signal 356 which may significantly improve object detection performance of the LIDAR system 300.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Moreover, aspects of the present disclosure may be embodied as a system, method, and/or computer program product. As such, aspects of the disclosed embodiments may be provided in the form of an entirely hardware embodiment, an entirely software embodiment, or a combination thereof.

Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs and computer programs products based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure.

It is expected that during the life of a patent maturing from this application many relevant systems, methods and computer programs will be developed and the scope of the terms LIDAR systems, tunable optical filters, optical and light filtering technologies, light projection technologies, light sensing technologies, and scanning mechanisms, are intended to include all such new technologies a priori.

The terms “comprise”, “comprising”, “include”, “including”, “having” and their conjugates mean “including but not limited to”. These terms encompass the terms “consisting of” and “consisting essentially of” which mean that the composition or method may include additional ingredients and/or steps if the additional elements and/or steps do not materially alter the novel characteristics of the claimed composition or method.

As used herein the term “about” refers to ±5 %.

Throughout this disclosure, various embodiments may be presented in a range format. Description in range format is merely for convenience and brevity and should not be construed as an inflexible limitation on the scope of the invention. Accordingly, the description of a range should be construed to include all the possible subranges as well as individual numerical values within that range.

It is appreciated that certain features of embodiments disclosed herein, which are, for clarity, described in the context of separate embodiments, may also be provided in combination in a single embodiment. Also, features described in combination in the context of a single embodiment may also be provided separately or in suitable sub-combinations in other embodiments described herein.

Publications, patents, and patent applications referred to in this disclosure are to be incorporated into the specification in their entirety by reference as if each individual publication, patent, or patent application was specifically and individually included in the disclosure. However, indication and/or identification of any such referenced document may not be construed as admission that the referenced document is available as prior art to embodiments disclosed hereon.

The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A LIDAR system, comprising:
a light source configured to emit light projected towards a field of view (FOV) of the LIDAR system;
a tunable optical filter having a dynamically adjustable passband;
a sensor configured to detect light received from the FOV via the tunable optical filter; and
at least one processor configured to:
determine at least one ambient light condition of an external environment of the LIDAR system;
adjust a width of the dynamically adjustable passband of the tunable optical filter according to the at least one ambient light condition to control an intensity of ambient light received by the sensor from the FOV via the tunable optical filter;
receive ToF signal data generated by the sensor, the ToF signal data is indicative of light projected by the LIDAR system and reflected from the FOV; and
receive ambient light signal data generated by the sensor, the ambient light signal data is indicative of ambient light received from the FOV.

2. The LIDAR system of claim 1, wherein the at least one ambient light condition comprises at least one of an intensity of the ambient light, and a wavelength of the ambient light.

3. The LIDAR system of claim 1, wherein the ambient light signal data is used for constructing an image of at least part of the FOV.

4. The LIDAR system of claim 3, wherein the at least one processor is configured to adjust the width of the dynamically adjustable passband of the tunable optical filter to transmit sufficient ambient light to the sensor for constructing the image of at least part of the FOV, such that:
in response to identifying low ambient light conditions, the at least one processor increases the width of the dynamically adjustable passband of the tunable optical filter, and
in response to identifying high ambient light conditions, the at least one processor reduces the width of the dynamically adjustable passband of the tunable optical filter.

5. The LIDAR system of claim 4, wherein the sufficient ambient light is determined based on comparison of an intensity of ambient light detected by the sensor and at least one predefined threshold.

6. The LIDAR system of claim 4, wherein the at least one processor is further configured to adjust the width of the dynamically adjustable passband of the tunable optical filter according to a tradeoff between sufficient ambient light and reduced ambient light noise.

7. The LIDAR system of claim 1, wherein the tunable optical filter is operable to adjust the width of the dynamically adjustable passband of the tunable optical filter within a predefined width range.

8. The LIDAR system of claim 1, wherein the tunable optical filter is operable to select the width of the dynamically adjustable passband of the tunable optical filter from a plurality of discrete width values.

9. The LIDAR system of claim 1, wherein the tunable optical filter comprises a mechanically movable optical filter having at least two states, wherein:
in a first state, the mechanically movable optical filter is positioned in an inbound optical path of the light received from the FOV and directed toward the sensor, and
in a second state, the mechanically movable optical filter is positioned out of the inbound optical path.

10. The LIDAR system of claim 1, wherein the tunable optical filter comprises a mechanically movable optical filter having at least two states, wherein:
in a first state, a first filtering region of the mechanically movable optical filter is positioned in an inbound optical path of the light received from the FOV and directed toward the sensor, and
in a second state, a second filtering region of the mechanically movable optical filter is positioned in the inbound optical path,
wherein the first filtering region is configured to transmit a different wavelength range from the second filtering region.

11. The LIDAR system of claim 1, wherein the tunable optical filter comprises an optical low pass filter (LPF) and an optical high pass filter (HPF) combined to form the dynamically adjustable passband, at least one of the optical LPF and the optical HPF is mechanically adjustable to adjust the width of the dynamically adjustable passband.

12. The LIDAR system of claim 1, further comprising a fixed optical filter associated with the sensor, the fixed optical filter is deployed in an inbound optical path of the light received from the FOV and directed toward the sensor such that the light received by the sensor from the FOV is transmitted via the fixed optical filter and the tunable optical filter,
wherein the fixed optical filter comprises at least two fixed passbands, a first fixed passband corresponding to a wavelength of the light projected by the light source of the LIDAR system and a second fixed passband corresponding to the wavelength of visible light,
wherein the width of the dynamically adjustable passband of the tunable optical filter is adjustable to at least a first passband and a second passband, the first passband corresponds to the first fixed passband of the fixed optical filter, and the second passband corresponds to both the first fixed passband and the second fixed passband of the fixed optical filter.

13. The LIDAR system of claim 12, further comprising removing the tunable optical filter from the inbound optical path such that the sensor receives light from the FOV only via the fixed optical filter.

14. The LIDAR system of claim 1, wherein the tunable optical filter comprises at least one of: a liquid crystal tunable filter (LCTF), a ring resonator, and an acousto-optical tunable filter (AOTF).

15. The LIDAR system of claim 1, wherein the tunable optical filter is configured such that the dynamically adjustable passband includes a wavelength of the light projected by the LIDAR system.

16. The LIDAR system of claim 1, wherein the at least one processor is further configured to adjust a center wavelength of the dynamically adjustable passband of the tunable optical filter according to a wavelength of the light projected by the LIDAR system.

17. The LIDAR system of claim 1, wherein the at least one ambient light condition is identified based on signal data generated by the sensor.

18. The LIDAR system of claim 1, wherein the at least one ambient light condition is identified based on data generated by at least one another sensor different from the sensor.

19. The LIDAR system of claim 1, wherein the ambient light signal data is generated by the sensor during at least one time period during which the light projected by the LIDAR system and reflected from at least one object in the FOV is estimated not to be received by the sensor.

20. The LIDAR system of claim 1, wherein the at least one processor is further configured to adjust the width of the dynamically adjustable passband in real-time by:
adjusting the width of the dynamically adjustable passband to set an increased width passband during at least one first time period of at least one scan cycle of the FOV during which the light projected by the LIDAR system and reflected from the FOV is estimated not to arrive the sensor, and
adjusting the width of the dynamically adjustable passband to set a reduced width passband corresponding to a wavelength of the light projected by the LIDAR system during at least one second time period of the at least one scan cycle during which the light projected by the LIDAR system and reflected from the FOV is estimated to arrive the sensor.

21. A method of using a LIDAR system for receiving ambient light used to construct an image of a field of view (FOV) of the LIDAR system, comprising:
using at least one processor for:
determining at least one ambient light condition of an external environment of the LIDAR system;
adjusting a width of a passband of a tunable optical filter having a dynamically adjustable passband according to the at least one ambient light condition to control an intensity of ambient light received from the FOV that is transmitted to a sensor of the LIDAR system via the tunable optical filter, the tunable optical filter is positioned downstream from the sensor such that the sensor receives light from the FOV via the tunable optical filter;
receiving ToF signal data generated by the sensor, the ToF signal data is indicative of light projected by the LIDAR system and reflected from the FOV; and
receiving ambient light signal data generated by the sensor, the ambient light signal data is indicative of ambient light received from the FOV.
